(19) United States
(12) Patent Application Publication
(10) Pub. No.: US 2026/0180710 A1
(43) Pub. Date: Jun. 25, 2026

(54) IMMW PPDU DESIGN

(71) Applicant: NXP USA, Inc., AUSTIN, TX (US)

(72) Inventors: Rui Cao, Sunnyvale, CA (US); Xiayu Zheng, San Jose, CA (US); Liwen Chu, San Ramon, CA (US); Hongyuan Zhang, Fremont, CA (US)

(21) Appl. No.: 19/411,796

(22) Filed: Dec. 8, 2025

Related U.S. Application Data
(60) Provisional application No. 63/738,087, filed on Dec. 23, 2024.
(60) Provisional application No. 63/747,924, filed on Jan. 22, 2025.

(51) Int. Cl. H04L 1/00; H04W 16/28; H04W 84/12

(52) U.S. Cl. CPC H04L 1/0006; H04W 16/28; H04W 84/12

(57) ABSTRACT

In an IEEE 802.11 wireless system, a wireless STA is configured to operate a wireless personal network in accordance with IEEE 802.11 protocol in a millimeter-wave frequency band using OFMD by generating an Integrated Millimeter Wave (IMMW) physical layer protocol data unit (PPDU) which includes an first IMMW preamble portion and an IMMW signaling (SIG) field, and a second IMMW preamble portion, and by transmitting the IMMW PPDU over at least a first signal bandwidth using at least a first tone plan.

### CROSS-REFERENCE TO RELATED APPLICATION AND PRIORITY CLAIM

This application claims the benefit of U.S. Provisional Patent Application No. 63/738,087, entitled “IMMW PPDU Design” filed on Dec. 23, 2024, and U.S. Provisional Patent Application No. 63/747,924 entitled “IMMW PPDU Design” filed Jan. 22, 2025, each of which is incorporated by reference in its entirety as if fully set forth herein.

### FIELD

The present disclosure is directed in general to communication networks. In one aspect, the present disclosure relates generally protocols for wirelessly transmitting data packets in a communications network.

### DESCRIPTION OF THE RELATED ART

In general, a communication protocol provides a set of rules that allow two or more entities of a communications network to communicate information via a variation of a physical quantity. An exemplary communication protocol defines rules, syntax, semantics, and synchronization of communications. Technical standards formalize uniform specifications for a communication protocol to enable interoperability of products made by different manufacturers. For example, the Institute of Electrical and Electronics Engineers (IEEE) is a professional organization that develops global standards in various industries, including telecommunications and consumer electronics. Exemplary communication protocol standards include the IEEE 802 standards for Local Area Networks (LAN) and Metropolitan Area Networks (MAN). The IEEE 802.11 standard sets protocols for Wireless Local Area Networking (WLAN) of computer communications. A typical protocol standard includes an original version of the protocol standard followed by amended versions of the protocol standard that make technical improvements and corrections to the original version or intervening versions of the standard. For example, enabling technology advances in the area of wireless communications, various wireless technology standards (including for example, the IEEE Standards 802.11a/b/g, 802.11n, 802.11ad, 802.11ac, 802.11ax, 802.11ay, 802.11be, and 802.11bn and their updates and amendments, as well as the IEEE Standard 802.11bq now in the process of being developed) have been introduced that are known to persons skilled in the art and are collectively incorporated by reference as if set forth fully herein fully. To guarantee interoperability between two or more entities of the communications network, techniques that identify the communication protocol and version of the communication protocol being used by the entities are desired.

### BRIEF DESCRIPTION OF THE DRAWINGS

The present invention may be understood, and its numerous objects, features and advantages obtained, when the following detailed description of a preferred embodiment is considered in conjunction with the following drawings. Elements in the drawings are illustrated for simplicity and clarity and have not necessarily been drawn to scale.

FIG. 1 is a block diagram of a wireless local area network (WLAN) in which wireless communication station (STA) devices transmit different types of physical layer protocol data units (PPDUs) having specified PPDU fields in specified sequences in accordance with selected embodiments of the present disclosure.

FIG. 2A illustrates field formats of a conventional very high throughput (VHT) single user (SU) PPDU in accordance with selected embodiments of the present disclosure.

FIG. 2B illustrates field formats of a conventional extremely high throughput (EHT) SU PPDU in accordance with selected embodiments of the present disclosure.

FIG. 3A illustrates a first preamble field format sequence of an integrated millimeter-wave (IMMW) data PPDU which is transmitted with a mixed format, minimum bandwidth signaling option in accordance with selected embodiments of the present disclosure.

FIG. 3B illustrates a first preamble field format sequence of an IMMW data PPDU which is transmitted with a mixed format, wide bandwidth signaling option in accordance with selected embodiments of the present disclosure.

FIG. 4A illustrates a second preamble field format sequence of an IMMW data PPDU which is transmitted with a mixed format, minimum bandwidth signaling option in accordance with selected embodiments of the present disclosure.

FIG. 4B illustrates a second preamble field format sequence of an IMMW data PPDU which is transmitted with a mixed format, wide bandwidth signaling option in accordance with selected embodiments of the present disclosure.

FIG. 5 illustrates a third preamble field format sequence of an IMMW data PPDU which is transmitted with a single green field format, minimum bandwidth signaling option in accordance with selected embodiments of the present disclosure.

FIG. 6 illustrates a fourth preamble field format sequence of an IMMW duplicate (DUP) PPDU which is transmitted with a mixed format, wide bandwidth signaling option in accordance with selected embodiments of the present disclosure.

FIG. 7A illustrates a fifth preamble field format sequence of an IMMW null data packet (NDP) PPDU which is transmitted with a mixed format, minimum bandwidth signaling option in accordance with selected embodiments of the present disclosure.

FIG. 7B illustrates a sixth preamble field format sequence of an IMMW NDP PPDU which is transmitted with a mixed format, minimum bandwidth signaling option with beam training fields in accordance with selected embodiments of the present disclosure.

FIG. 7C illustrates a sixth preamble field format sequence of an IMMW NDP PPDU which is transmitted with a mixed format, wide bandwidth signaling option with beam training fields in accordance with selected embodiments of the present disclosure.

FIG. 8A illustrates a seventh preamble field format sequence of an IMMW NDP PPDU which is transmitted with a mixed format, mixed bandwidth signaling option for beam refinement protocol (BRP) training in accordance with selected embodiments of the present disclosure.

FIG. 8B illustrates an eighth preamble field format sequence of an IMMW NDP PPDU which is transmitted with a mixed format, wide bandwidth signaling option with beam training fields in accordance with selected embodiments of the present disclosure.

FIG. 8C illustrates a ninth preamble field format sequence of an IMMW NDP PPDU which is transmitted with a mixed format, wide bandwidth signaling option with beam training fields in accordance with selected embodiments of the present disclosure.

FIG. 8D illustrates a tenth preamble field format sequence of an IMMW NDP PPDU which is transmitted with a mixed format, minimum bandwidth signaling option for a downclocked legacy portion in accordance with selected embodiments of the present disclosure.

FIG. 8E illustrates a eleventh preamble field format sequence of an IMMW NDP PPDU which is transmitted with a mixed format, multiple minimum bandwidth signaling option for a downclocked legacy portion in accordance with selected embodiments of the present disclosure.

FIG. 9A illustrates a twelfth preamble field format sequence of an IMMW NDP PPDU which is transmitted with a single green field format, minimum bandwidth signaling option in accordance with selected embodiments of the present disclosure.

FIG. 9B illustrates a thirteenth preamble field format sequence of an IMMW NDP PPDU which is transmitted with a single green field format, minimum bandwidth signaling option with beam training fields in accordance with selected embodiments of the present disclosure.

FIG. 10A illustrates a fourteenth preamble field format sequence of an IMMW data PPDU which is transmitted with a mixed format, minimum bandwidth signaling option in accordance with selected embodiments of the present disclosure.

FIG. 10B illustrates a fifteenth preamble field format sequence of an IMMW data PPDU which is transmitted with a mixed format, mixed bandwidth signaling option in accordance with selected embodiments of the present disclosure.

FIG. 11A illustrates a sixteenth preamble field format sequence of an IMMW data PPDU which is transmitted with a mixed format, minimum bandwidth signaling option in accordance with selected embodiments of the present disclosure.

FIG. 11B illustrates a seventeenth preamble field format sequence of an IMMW data PPDU which is transmitted with a mixed format, mixed bandwidth signaling option in accordance with selected embodiments of the present disclosure.

FIG. 12 illustrates an eighteenth preamble field format sequence of an IMMW data PPDU which is transmitted with a mixed format, minimum bandwidth signaling option in accordance with selected embodiments of the present disclosure.

FIG. 13 depicts an exemplary logic flow diagram illustrating an PPDU modulation encoding and signaling procedure implemented in accordance with selected embodiments of the present disclosure.

### DETAILED DESCRIPTION

A system, apparatus, and methodology are described for enabling wireless communication station (STA) devices to use Integrated mmWave (IMMW) physical layer protocol data units (PPDUs) having specified formats for preamble signaling fields in compliance with emerging 802.11 standards, such as the 802.11bq. In selected embodiments, the transmitting STA device may generate an IMMW PPDU having a PHY preamble which reuses at least part of the Orthogonal Frequency-Division Multiplexing (OFDM) definition from legacy 802.11 PHY OFDM PPDU protocols in the sub-7 GHz signaling space with upclocking to wider bandwidth, but the ordering of the preamble signaling fields provides a PPDU structure that is efficient and reliable for forward and backward compatibility for future generation protocols. For example, a first disclosed IMMW data PPDU format has a mixed tone format PHY which retains a legacy preamble field sequence (e.g., L-STF, L-LTF, U-SIG), replaces one or more legacy signal fields (L-SIG, RL-SIG) with a modification of the universal signaling field U-SIG to indicate forward compatibility, and includes a first IMMW preamble field sequence (e.g., IMMW-SIG, IMMW-STF, IMMW-LTF) in front of the data and post-amble fields. In another example, a second disclosed IMMW data PPDU format has a mixed tone format PHY which retains a legacy preamble field sequence (e.g., L-STF, L-LTF, U-SIG), replaces one or more legacy signal fields (L-SIG, RL-SIG) with a modification of the universal signaling field U-SIG to indicate forward compatibility, and includes a second IMMW preamble field sequence (e.g., IMMW-STF, IMMW-LTF, IMMW-SIG) in front of the data and post-amble fields. In another example, a third disclosed IMMW data PPDU format has a single tone format PHY which does not include a legacy preamble field sequence, but instead includes a third IMMW preamble field sequence (e.g., IMMW-STF, IMMW-LTF, U-SIG) in front of the data and post-amble fields. In another example, a fourth disclosed IMMW duplicate (DUP) or training PPDU format has a mixed tone format PHY which retains a legacy preamble field sequence (e.g., L-STF, L-LTF, U-SIG) and includes a fourth IMMW preamble portion which may include at least an IMMW signaling field (e.g., IMMW-SIG) in front of the data and post-amble fields. In another example, a fifth disclosed IMMW null data packet (NDP) PPDU format has a mixed tone format PHY which retains a legacy preamble field sequence (e.g., L-STF, L-LTF, U-SIG) and includes a fifth IMMW preamble field sequence (e.g., IMMW-SIG, IMMW-STF, IMMW-LTF) in front of a post-amble field. In another example, a sixth disclosed IMMW NDP PPDU format has a single tone format PHY which does not include a legacy preamble field sequence, but instead includes a sixth IMMW preamble field sequence (e.g., IMMW-STF, IMMW-LTF, U-SIG) in front of a post-amble field. In another example, a seventh disclosed IMMW data PPDU format has a mixed tone format PHY which retains a legacy preamble field sequence (e.g., L-STF, L-LTF, L-SIG, RL-SIG) and includes a modified universal signaling field U-SIG with Cyclic Redundancy Check (CRC) encoding based on the L-SIG, RL-SIG, and U-SIG fields, and includes a seventh IMMW preamble field sequence (e.g., IMMW-SIG, IMMW-STF, IMMW-LTF) in front of the data and post-amble fields. In another example, an eighth disclosed IMMW data PPDU format has a mixed tone format PHY which retains a legacy preamble field sequence (e.g., L-STF, L-LTF, L-SIG) and includes a modified universal signaling field U-SIG with CRC encoding based on the L-SIG and U-SIG fields, and includes an eighth IMMW preamble field sequence (e.g., IMMW-SIG, IMMW-STF, IMMW-LTF) in front of the data and post-amble fields.

It will be understood by those skilled in the art that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present disclosure may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussions of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize, in light of the description herein, that the disclosure can be practiced without one or more of the specific features or advantages of a particular embodiment. In other instances, additional features and advantages may be recognized in certain embodiments that may not be present in all embodiments of the disclosure.

References throughout this specification to “one embodiment”, “an embodiment,” “selected embodiments,” or similar language means that a particular feature, structure, or characteristic described in connection with the indicated embodiment is included in at least one embodiment of the present disclosure. Thus, the phrases “in one embodiment”, “in an embodiment,” “selected embodiments,” and similar language throughout this specification may, but do not necessarily, all refer to the same embodiment.

As disclosed herein, a significant constraint in the design of new wireless communication protocols is often the need to maintain backward compatibility, typically by requiring new signal formats, such as preambles, to be recognizable and understandable by devices operating under legacy standards. Such a constraint often forces sub-optimal design choices and limits the potential efficiency gains of a new PHY structure. In addition, using the same or equal rate for different spatial streams when a MIMO channel has a large condition number is not optimal in term of capacity. To have error free or tolerable error level transmission while maximizing throughput, stronger spatial streams most likely operate at lower rates which the corresponding spatial subchannels can support, and weaker spatial streams most likely operate at higher rate which the corresponding spatial subchannels can support. The final PER performance and throughput are bottlenecked by the weaker streams. To address this limitation and improve transmit beamforming gain, different rates may be used for different spatial streams when transmit beamforming is used with MIMO channels having a large condition number (e.g., better PER is achieved for the same effective rate transmission as equal modulation rate, thereby resulting in higher throughput). Indeed, transmit beamforming gain can be fully exploited when the rate assigned for each spatial stream approaches its own capacity. While there are encoding and decoding challenges that arise from using different rates for different spatial streams, unequal modulation without changing the code rate can be another option for easier implementation to improve system performance, such as throughput and latency. While this approach was recognized with the IEEE 802.11n standard which introduced the optional feature of using unequal modulations for different spatial streams MIMO transmit beamforming, this feature is no longer adopted in the later standards, such as IEEE 802.11ac, 802.11ax and 802.11be.

In the context of the present disclosure, the ongoing efforts to define a protocol for IMMW signaling seek to leverage the successful foundation of existing wireless standards. For example, the proposed IMMW PHY attempts to reuse the Orthogonal Frequency-Division Multiplexing (OFDM) definition as defined in the 802.11 PHY OFDM PPDU in the sub-7 GHz band. This approach aims to provide a familiar and robust basis for the new standard and to allow a simple receiver detection state machine, including using the legacy packet detection logic. In addition, the IMMW PHY seeks to fully capitalize on the large bandwidth available in the mmWave band and consequently achieve a higher data rate by providing an upclocked version of the existing OFDM definition. However, the introduction of any new standard must consider the operational environment, especially the requirement for co-existence with previous standards operating in the mmWave band, such as the 802.11ad, 802.11ay, and 802.11aj standards which rely on energy detection mechanisms for channel sensing and basic operation. However, because the preamble of IMMW PPDUs does not need to be understandable by legacy standards devices, the freedom from legacy preamble comprehension presents an opportunity to overcome the design limitations imposed by strict backward compatibility, which would otherwise necessitate compromises in the PHY design. In view of the foregoing, there is disclosed herein an improved signaling protocol and physical layer structure for the integrated millimeter-wave (IMMW) standard which leverages the relaxed co-existence requirement to enable a more efficient PHY design to be used for the IMMW mm Wave standard, thereby maximizing the utilization of the large available bandwidth and enhancing the overall data rate and spectral efficiency of the next generation of mmWave communication systems.

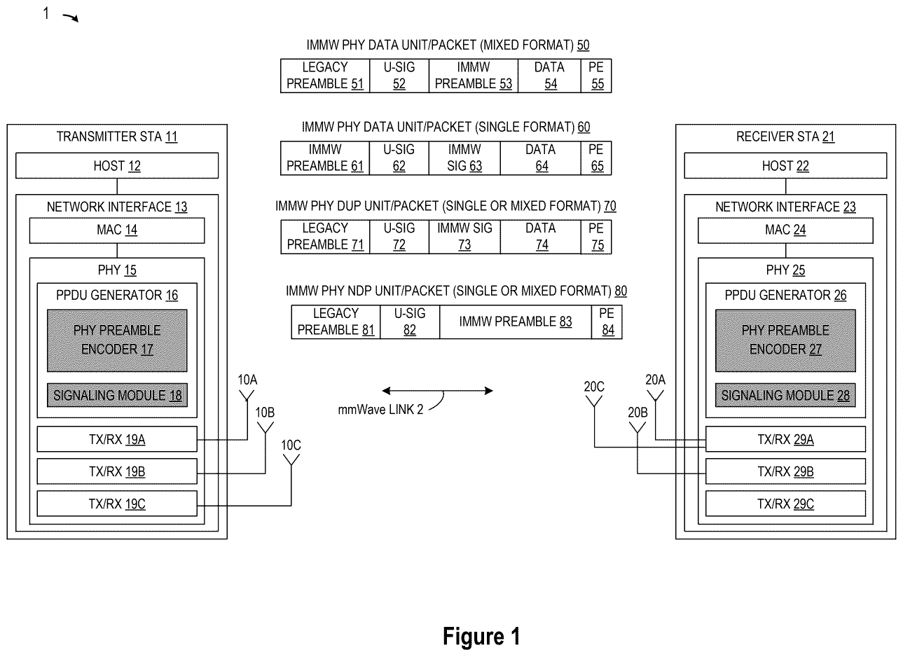

To provide an improved understanding of selected embodiments of the present disclosure, reference is now made to FIG. 1 which depicts a block diagram of a wireless local area network (WLAN) 1 in which wireless communication station (STA) devices 11, 21 transmit different types of physical layer protocol data units (PPDUs) 50, 60, 70, 80 having specified PPDU fields. As depicted, the transmitter station 21 includes a host processor 12 coupled to a network interface 13. As will be appreciated, the host processor 12 may include a processor configured to execute machine readable instructions stored in a memory device (not shown), e.g., random access memory (RAM), read-only memory (ROM), a flash memory, or other storage device. In selected embodiments, the network interface 13 includes one or more integrated circuits (IC) devices configured to operate a local area network (LAN) protocol. To this end, the network interface 13 may include a medium access control (MAC) processor 14 and a physical layer (PHY) processor 15. In selected embodiments, the MAC processor 14 is implemented as an 802.11bq MAC processor 14, and the PHY processor 15 is implemented as an 802.11bq PHY processor 15. The PHY processor 15 includes a plurality of transceivers 19A-C which are coupled to a plurality of antennas 10A-C. Although three transceivers 19A-C and three antennas 10A-C are illustrated, the transmitter station 21 may use any suitable number of transceivers 19 and antennas 10 in other embodiments. Each of transceivers 19A-C includes a transmitter signal path and a receiver signal path, e.g., mixed-signal circuits, analog circuits, and digital signal processing circuits for implementing radio frequency and digital baseband functionality. PHY processor 15 incudes at least one amplifier (e.g., low noise amplifier or power amplifier), data converter, and circuits that perform discrete Fourier transform (DFT), inverse discrete Fourier transform (IDFT), modulation, and demodulation. In addition, the transmitter station 21 may have more antennas 10 than transceivers 19, in which case antenna switching techniques are used to switch the antennas 10 between the transceivers 19. In selected embodiments, the MAC processor 14 is implemented with one or more integrated circuit (IC) devices, and the PHY processor 15 is implemented on one or more additional IC devices. In other embodiments, at least a portion of the MAC processor 14 and at least a portion of the PHY processor 15 are implemented on a single IC device. In various embodiments, the MAC processor 14 and the PHY processor 15 are configured to operate according to at least a first communication protocol (e.g., 802.11bq). In other embodiments, the MAC processor 14 and the PHY processor 15 are also configured to operate according to one or more additional communication protocols (e.g., according to the IEEE 802.11ad, 802.11ay, or 802.11aj standard). Using the communication protocol(s), the transmitter station 21 is operative to create a wireless local area network (WLAN) 1 in which one or more client receiver stations (e.g., 21) may communicate with the transmitter station 21 and/or with other client stations (not shown) located within the WLAN 1. Although a single client station 21 is illustrated in FIG. 1, the WLAN 1 may include any suitable number of client stations in various scenarios and embodiments.

As depicted, the wireless client receiver station 21 includes a host processor 22 coupled to a network interface 23. In selected embodiments, the network interface 23 includes one or more IC devices configured to operate as discussed below. For example, the depicted network interface 23 may include a MAC processor 24 and a PHY processor 25. In selected embodiments, the MAC processor 24 is implemented as an 802.11bq MAC processor 24, and the PHY processor 25 is implemented as an 802.11bq PHY processor 25. The PHY processor 25 includes a plurality of transceivers 29A-C coupled to a plurality of antennas 20A-C. Although three transceivers 29A-C and three antennas 20A-C are illustrated, the receiver station 21 may include any suitable number of transceivers 29 and antennas 20. In addition, the client receiver station 21 may include more antennas than transceivers, in which case antenna array switching techniques are used. In selected embodiments, the MAC processor 24 is implemented on at least a first IC device, and the PHY processor 25 is implemented on at least a second IC device. In other embodiment, at least a portion of the MAC processor 24 and at least a portion of the PHY processor 25 are implemented on a single IC device.

In operation, the transmitter station 11 is configured to transmit or exchange data frames 50, 60, 70, 80 with the receiver station 21 over a mmWave link 2 by using beamforming with antenna arrays 10 to compensate for the high pathloss. To this end and as described more fully hereinbelow, each transmitting device (e.g., transmitter station 11) includes a PPDU generator module 16 in the PHY processor 15 which is configured to generate an IMMW PHY data unit or packet frames 50, 60, 70, 80. In particular, the PPDU generator module 16 may include a PHY preamble encoder module 17 which is configured to generate a PPDUs PHY preamble having a specified format with a defined sequence of preamble signaling fields in compliance with emerging 802.11 standards, such as the 802.11bq. In addition, the PPDU generator module 16 may include a signaling module 18 which is configured to generate predetermined bit sequences for each field in the IMMW PHY data unit or packet frames 50, 60, 70, 80. For example, the PPDU generator module 16 may be configured to generate a first IMMW PHY data unit or packet frame 50 having a mixed tone format that is applied to a legacy preamble portion 51, a U-SIG preamble portion 52, an IMMW preamble portion 53, a data payload portion 54, and a post-amble portion 55. In addition or in the alternative, the PPDU generator module 16 may be configured to generate a second IMMW PHY data unit or packet frame 60 having a single tone format that is applied to an IMMW preamble portion 61, a U-SIG preamble portion 62, an IMMW-SIG preamble portion 63, a data payload portion 64, and a post-amble portion 65. In addition or in the alternative, the PPDU generator module 16 may be configured to generate a third IMMW PHY DUP unit or packet frame 70 having a single tone format or a mixed tone format that is applied to a legacy preamble portion 71, a U-SIG preamble portion 72, an IMMW preamble portion 73, a data payload portion 74, and a post-amble portion 75. In addition or in the alternative, the PPDU generator module 16 may be configured to generate a fourth IMMW PHY NDP unit or packet frame 80 having a single tone format or a mixed tone format that is applied to a legacy preamble portion 81, a U-SIG preamble portion 82, an IMMW preamble portion 83, and a post-amble portion 84.

In addition, the client receiver station 21 is configured to transmit or exchange data frames 50, 60, 70, 80 with the transmitter station 11 over a mmWave link 2 by using beamforming with antenna arrays 20 to compensate for the high pathloss. To this end and as described more fully hereinbelow, each client receiver device 21 includes a PPDU generator module 26 in the PHY processor 25 which is configured to generate an IMMW PHY data unit or packet frames 50, 60, 70, 80. In particular, the PPDU generator module 26 may include a PHY preamble encoder module 27 which is configured to generate a PPDUs PHY preamble having a specified format with a defined sequence of preamble signaling fields in compliance with emerging 802.11 standards, such as the 802.11bq. In addition, the PPDU generator module 26 may include a signaling module 28 which is configured to generate predetermined bit sequences for each field in the IMMW PHY data unit or packet frames 50, 60, 70, 80.

As disclosed herein, the transmitter station 11 transmits data streams 50, 60, 70, 80 to one or more client receiver stations 21 in the WLAN 1. The transmitter station 11 is configured to operate according to at least a first IMMW communication protocol which may be referred to as IEEE 802.11bq communication protocol.

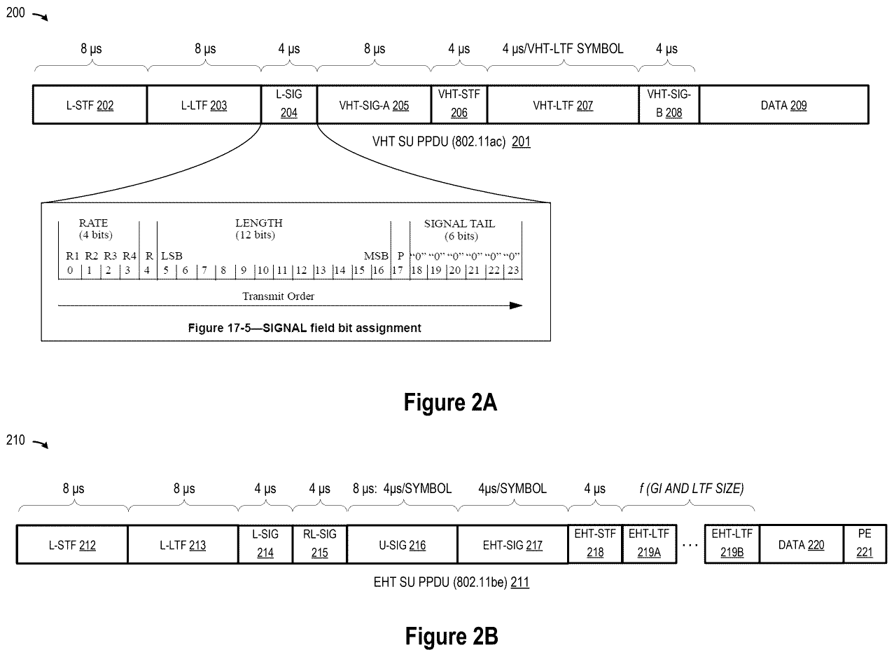

To provide a contextual understanding for the present disclosure, reference is now made to FIG. 2A which depicts a data unit format 200 to illustrate the sequencing of fields 202-209 and corresponding timing durations of a very high throughput (VHT) single user (SU) PPDU 201 which conforms to the IEEE 802.11ac standard and occupies a 20 megahertz (MHz) frequency band. In order to maintain backward compatibility with previous 802.11 standards, the depicted data unit format 200 includes a legacy PPDDU preamble or prefix portion having legacy short training field (L-STF) 202 (generally used for packet commencement detection, achieving coarse frequency and time synchronization, and automatic gain control), a legacy long training field (L-LTF) 203 (generally used for refining the frequency and time synchronization and performing channel estimation for the subsequent L-SIG field), and a legacy signal field (L-SIG) 204 (which is encoded with information required by legacy stations to calculate the Network Allocation Vector (NAV), specifically the transmission duration). In particular, the L-SIG field 204 may include a 24-bit sequence which conveys rate information (4 bits), transmission length information (12 bits), parity information (1 bit), and signal tail bits (6 bits). In addition, the depicted data unit format 200 includes VHT Signaling and Training Fields 205-207 which convey information specific to the 802.11ac transmission mode, including bandwidth, MIMO parameters, and the data duration, as well as providing necessary training sequences for channel estimation. In particular, the Very High Throughput Signal Field A (VHT-SIG-A) 205 contains vital VHT-specific information necessary for all $802.11ac receivers to begin processing the VHT transmission. In addition, the Very High Throughput Short Training Field (VHT-STF) 206 conveys information used by VHT receivers to achieve additional MIMO AGC refinement. In addition, the Very High Throughput Long Training Field (VHT-LTF) 207 includes one or more repeated symbols used for specifying the number of spatial streams (N_SS) or the number of necessary effective streams used for MIMO operation. The depicted data unit format 200 also includes secondary signaling and data payload fields 208-209 which provide specific parameters for payload decoding and containing the transmitted information. In particular, the Very High Throughput Signal Field B (VHT-SIG-B) 208 contains the precise per-user information needed for decoding the payload, such as by specifying the Modulation and Coding Scheme (MCS) index and the length of the payload (in bytes) for the intended recipient(s) in a given transmission. In addition, the final data field 209 contains the actual Physical Layer Service Data Unit (PSDU) which is the network layer payload. This data is scrambled, encoded with forward error correction (FEC), modulated using the MCS specified in VHT-SIG-B, and transmitted across the full VHT bandwidth using the multiple spatial streams defined in the VHT-LTF training sequence.

To provide additional contextual understanding for the present disclosure, reference is now made to FIG. 2B which depicts a data unit format 210 to illustrate the sequencing of fields 212-221 and corresponding timing durations of an extremely high throughput (EHT) single user (SU) PPDU 211 which conforms to the IEEE 802.11be standard and occupies a 20 megahertz (MHz) frequency band. In order to ensure universal detection and co-existence across all preceding 802.11 standards, the depicted data unit format 210 includes a legacy and universal signaling PPDDU preamble or prefix portion, an EHT PPDU preamble or prefix portion, and a data and extension field portion. The legacy preamble portion includes a legacy short training field (L-STF) 212 (generally used for packet commencement detection, achieving coarse frequency and time synchronization, and automatic gain control), a legacy long training field (L-LTF) 213 (generally used for refining the frequency and time synchronization and performing channel estimation for the subsequent L-SIG field), and a legacy signal field (L-SIG) 214 (which is encoded with information required by legacy stations to calculate the Network Allocation Vector (NAV), specifically the transmission duration). In addition, the depicted data unit format 210 includes enhanced universal signaling fields 215-216 to convey information that is designed to be decoded by a broad range of 802.11 devices operating a different clock rates and spectrum bands, including the Repeated Legacy Signal Field (RL-SIG) 215 and a Universal Signaling Field (U-SIG) 216. The depicted data unit format 210 also includes EHT PPDU preamble signaling and training fields 217-219 to convey information specific to the 802.11be transmission, including the Extremely High Throughput Signal Field (EHT-SIG) 217 (which is the high-bandwidth control field carrying the most detailed parameters for receivers), the Extremely High Throughput Short Training Field (EHT-STF) 218 (which is a training sequence used by the receiver to complete final Automatic Gain Control (AGC) convergence and perform advanced channel tracking initialization necessary for handling the complexity of EHT's spatial streams and ultra-wide bandwidths), and the Extremely High Throughput Long Training Field(s) (EHT-LTF) 219A-B (which provide the most detailed training sequence necessary for Multi-User MIMO and beamforming). In addition, the final data and extension field portion includes an EHT data field 220 (which carries the scrambled, encoded, and modulated Physical Layer Service Data Unit (PSDU), which contains the MAC Protocol Data Units (MPDUs)) and the packet extension (PE) field 221 which is a no transmission period appended to the end of the PPDU which allows additional time for processing the received signal, particularly for high-bandwidth/high-complexity transmissions.

In the context of the present disclosure, it will be understood by those skilled in the art that the IEEE 802.11 standard (a.k.a., Wi-Fi) has been amended to provide very high data throughput performance in real-world, high density scenarios. For example, there are advanced techniques being addressed in IEEE 802.11bq standard which center on integrating Millimeter-Wave (mm Wave) operation, specifically the 60 GHz band, into the mainstream 802.11 architecture by combining the benefits of the ultra-high-speed mm Wave spectrum with the robust features of modern Wi-Fi, such as Multi-Link Operation (MLO) and Medium Access Control (MAC) enhancements developed in 802.11be (Wi-Fi 7). In particular, the IEEE 802.11bq protocol discussion will seek to provide an IMMW PPDU design that achieves better efficiency and allows a simple receiver detection state machine. In addition, IMMW PPDU design can be compatible with future generation standards with a PHY preamble structure that supports single-user (SU) transmission and can easily extend to multi-user transmission.

To meet these challenges, there is disclosed herein a plurality of IMMW PPDU designs which may have one or more specified formats for the preamble signaling fields in compliance with emerging 802.11 standards, such as the 802.11bq. In particular, the PHY format and structure may be defined for an IMMW data PPDU which may be used to transfer data. In addition, the PHY format and structure may be defined for an IMMW duplicate (DUP) PPDU which is used mainly for the management or control frame. In addition, the PHY format and structure may be defined for an IMMW null-data packet (NDP) PPDU which is used for beam training, NDP beacon, or channel sounding. As disclosed herein, each of the IMMW data PPDU, IMMW DUP PPDU, and IMMW NDP PPDU may be designed with either a “mixed format” or a single “format.” In the “mixed format” design, two different tone plans are used for the IMMW PPDU, with a legacy tone plan used for the beginning preamble portion up to the second STF field, and with a second tone plan used for ending preamble portion beginning with the second STF field. In the single “format” (or “green field” format) design, a single tone plan is used for the entire IMMW PPDU.

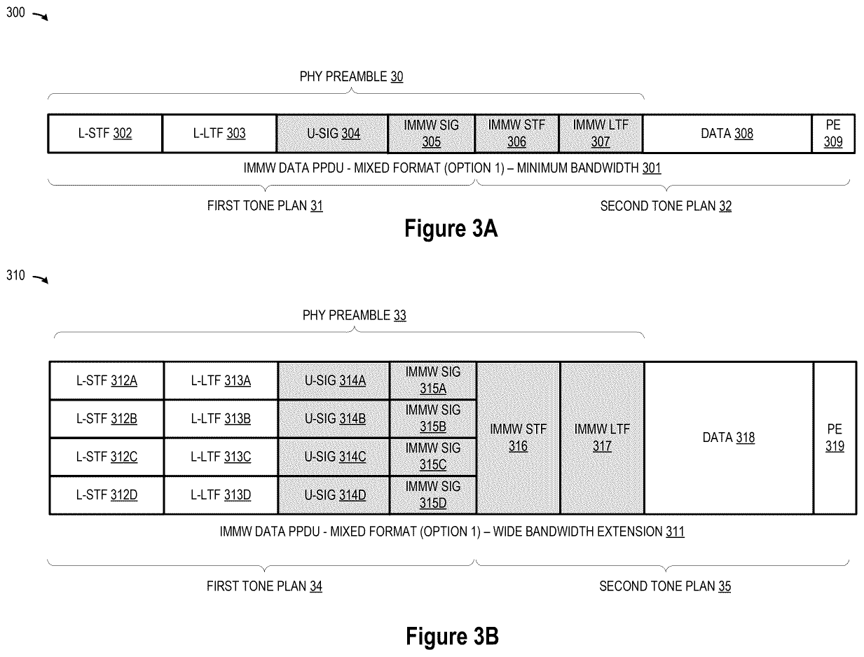

To provide additional details for an improved understanding of selected embodiments of the present disclosure, reference is now made to FIG. 3A which illustrates a first preamble field format sequence 300 of an integrated millimeter-wave (IMMW) data PPDU 301 which is transmitted with a mixed format, minimum bandwidth signaling option. The first preamble field format 300 includes a first defined PHY preamble sequence 30 (L-STF/L-LTF/U-SIG/IMMW-SIG/IMMW-STF/IMMW-LTF) that is extendable to future versions of the IEEE 802.11 communication protocol without further increasing the complexity of auto-detection at the receiver from that of previous IEEE 802.11 communication protocols. The PHY preamble portion 30 of the new data unit format is future-proof, e.g., devices compliant with future version of the IEEE 802.11bq communication protocol will not need to change the auto-detection state machine of the receiver and the auto-detection scheme is compatible with legacy versions of the IEEE 802.11 communication protocol. The PHY preamble portion 30 of the new data unit format implements unified signaling for new versions of the communication protocol (i.e., 802.11bq communication protocol and beyond). The PHY preamble portion 30 of the new data unit format replaces the legacy signal L-SIG field with a modified universal signal field (U-SIG 304) and includes new IMMW fields 305-307 (e.g., a IMMW-SIG, IMMW STF, IMMW LTF) that are included in the preamble of data units compliant with new versions of the communication protocol to explicitly signal the version of the data unit format and other useful information. In at least one embodiment, the PHY preamble portion 30 of the new data unit format includes an IMMW-SIG field 305 after the U-SIG field 304, and also includes an IMMW-STF field 306 and an IMMW-LTF field 307 in sequence after the IMMW-SIG field 305.

As depicted, the IMMW data PPDU 301 includes a PHY preamble portion 30 and a data and extension field portion 308-309. The PHY preamble portion 30 does not include a Length subfield, but instead includes a Legacy Short Training Field (L-LTF) 302, a Legacy Long Training Field (L-LTF) 303, and a universal signal field (U-SIG) 304, followed by an IMMW signal field (IMMW SIG) 305, an IMMW Short Training Field (IMMW-STF) 306 (which is the second STF field), and an IMMW Long Training Field (IMMW-LTF) 307. The data and extension field portion includes a data field 308 and the packet extension (PE) field 309. With the mixed format design, a first tone plan 31 is used to modulate and transmit the L-STF, L-LTF, U-SIG and IMMW SIG fields 302-305, while a second tone plan 32 is used to modulate and transmit the IMMW-STF, IMMW-LTF, data and PE fields 306-309.

In the PHY preamble portion 30, the contents of the legacy portion fields (L-STF 302, L-LTF 303) are known to those skilled in the art, and will not be detailed other than to note that they are the same as sub-7 GHz mixed format OFDM PPDU, and reuse the same packet detection logic from the previous generation protocols. However, the legacy portion fields (L-STF 302, L-LTF 303) can be upclocked from the 20 MHz tone plan, such as by using an 8× upclock to 160 MHz.

The PHY preamble portion 30 also includes the universal signal field (U-SIG) 304 which is configured to directly indicate forward compatibility. Since there is no need for backward compatibility with the IMMW PPDU, the legacy L-SIG field from earlier protocols can be replaced by the U-SIG field 304 which can provide better CRC protection and signal more information. In particular, the U-SIG field 304 provides better CRC protection by including a 6-bit CRC field. In addition, the U-SIG field 304 may include version-independent information for coexistence which specifies one or more PHY parameters that do not change for future generations. Examples of version-independent coexistence parameters may include, but are not limited to, information specifying a PHY_version_identifier (3 bits), BSS Color (6 bits), TXOP (7 bits), DL/UL (1 bits), BW, etc.

In addition, the U-SIG field 304 may include a LENGTH field to indicate the duration of the PPDU 301. In a first design option, the LENGTH field of the U-SIG field 304 may specify or indicate the number of OFDM symbols of the PPDU 301. In a second design option, the LENGTH field of the U-SIG field 304 may specify or indicate the number of bytes of the PPDU 301. In a third design option, the LENGTH field of the U-SIG field 304 may specify or indicate the time duration of the PPDU in units of micro-second, 4 micro-second, etc.

In addition, the U-SIG field 304 may include version-dependent information or fields, if needed. Examples of version-independent information in the U-SIG field 304 include, but are not limited to, information specifying the IMMW-SIG symbols (5 bits), IMMW-SIG MCS, PPDU format, and the like.

The PHY preamble portion 30 may also include the IMMW signal (IMMW SIG) field 305 which is an additional signaling field conveying the physical layer (PHY) configuration parameters needed for the 60 GHz mmWave transmission. For example, the IMMW SIG field 305 may include information bits needed to decode or parse the IMW data PPDU 301, such as user specific information (e.g., MCS, Nss, coding, etc.), beam training (TRN) field parameters, and the like.

After the IMMW SIG field 305, the PHY preamble portion 30 includes the IMMW-STF field 306 (which conveys initial synchronization and automatic gain control (AGC) adjustment information for the receiver operating in the 60 GHz mmWave band) and the IMMW-LTF field 307 (which facilitates accurate channel estimation for the high-speed data transmission across the 60 GHz mmWave band). After the PHY preamble portion 30, the IMMW data PPDU 301 includes a data field 308 and the packet extension (PE) field 309. In selected embodiments, a postamble field may optionally be appended after the data field 308 for use with providing end-of-packet beam refinement. In such embodiments, the postamble field may have a definition that is similar to a training (TRN) field. As disclosed, the PE field 309 provides extra time for receiver to turnaround. The exact duration of the PE field 309 can be specified for the 802.11bq protocol so that is longer or shorter than previous standards. However, in selected embodiments, the PE field 309 may be omitted if the postamble field exists.

As disclosed herein with respect to the mixed format IMMW data PPDU 301, the first tone plan 31 is applied to a first portion of the IMMW data PPDU 301 which includes fields 301-305. In a second or latter portion of the IMMW data PPDU 301, a second tone plan 32 is applied, beginning with the IMMW-STF field 306 and continuing through at least the data field 308. For example, the second tone plan 32 can reuse the 802.11ac/11ax OFDM tone plan.

In selected embodiments, the first tone plan 31 that is applied to at least the U-SIG and IMMW-SIG fields 304-305 may re-use the legacy tone plan for sub-7 GHz L-STF/L-LTF field encoding. In a first legacy tone plan option, the first tone plan 31 may use 48 data subcarriers (tones) to carry the information bits with a half-rate (½) binary convolutional code (BCC) error correction coding to improve error correction capability to yield 24-bits per-symbol. In a second tone plan option, the first tone plan 31 may use 52 data subcarriers (tones) to carry the information bits with a half-rate BCC error correction coding to improve error correction capability to yield 26-bits per-symbol. In this second tone plan option, the U-SIG and IMMW-SIG fields 304-305 will be based on 56 tones in keeping with the 802.11ax/be/bn standards. In this case, the L-LTF field 303 needs to add two-bits on each side of the sequence to make it compatible with the 56-tone plan. To provide the additional 4-bit design for good L-LTF Peak-to-Average Power Ratio (PAPR) and good L-STF-to-L-LTF correlation property, the initial acquisition should not change the original 52-tone L-LTF. An example 56-tone L-LTF field (L-LTF_56) would be L-LTF_56=[−1, −1, L-LTF, −1, 1].

In another embodiment, the L-STF field 302 may also be extended to occupy 56 tones by adding one loaded tone to each side of the L-STF sequence. To provide the additional 4-bit design for good L-STF, an example 56-tone L-STF field (L-STF_56) would be L-STF_56=[1+j, 0, STF_52, 0, −1−j]

With the IMMW protocol leveraging the extremely wide frequency bands available in the 42 GHz to 71 GHz range, the IMMW PPDU can implement a wide bandwidth extension by applying upclocking and OFDM scaling to achieve high data rates by proportionally increasing the channel bandwidth while keeping the OFDM symbol duration the same. Instead of defining an entirely new OFDM structure, the IMMW PPDU adopts an upclocked version of a well-established sub-PPDU format. In this way, the total channel bandwidth scales linearly with the upclocking factor. For instance, an 8× upclocking of a 40 MHz PPDU results in a 320 MHz IMMW channel.

In the IMMW context, the wide bandwidth extension requires the signaling fields to be robust and universally readable across the entire spectrum. To this end, the critical fields like the L-SIG and U-SIG are repeated and/or duplicated across all 20 MHz subchannels that make up the wideband channel (e.g., 320 MHz=16×20 MHz channels). This ensures any station listening on any part of the channel can detect the start of the PPDU and extract the necessary duration information. The use of this wide bandwidth in the mmWave band is a defining feature of the IMMW standard, enabling high-speed applications.

To provide additional details for an improved understanding of selected embodiments of the present disclosure, reference is now made to FIG. 3B which illustrates a first preamble field format sequence 310 of an IMMW data PPDU 311 which is transmitted with a mixed format, wide bandwidth signaling option. As depicted, the IMMW data PPDU 311 includes a first defined PHY preamble sequence 33 (L-STF/L-LTF/U-SIG/IMMW-SIG/IMMW-STF/IMMW-LTF) and a data and extension field portion 318-319. In particular, the disclosed PHY preamble sequence 33 includes four fields 312-315 that are duplicated over four minimum bandwidth channels (e.g., 20 MHz) of the wider channel bandwidth and two fields 316-317 that extend over the wider channel bandwidth (e.g. 160 MHz, 320 MHz, 640 MHz, 1280 MHz, etc.). The six fields of the PHY preamble sequence 33 are implemented as a plurality of preamble fields for each 20 MHz channel of the signal bandwidth (e.g., L-LTF 312A, L-LTF 313A, U-SIG 314A, and IMMW SIG 315A) that are duplicated over the entire signal bandwidth, followed by two fields (IMMW-STF 316 and IMMW-LTF 317) which extend over the wider signal bandwidth. In selected embodiments, “duplicated” may imply that the contents (e.g., data, information, bits, etc.) of each field for a 20 MHz channel are duplicated across the signal bandwidth and/or are the same for each corresponding field in other 20 MHz channels of the PPDU. For example, the contents of the first L-STF field 312A in the first or top 20 MHz channel of the IMMW data PPDU 311 may be repeated and/or the same as the contents of the L-STF fields 312B-D in the other 20 MHz channels.

As depicted, the IMMMW Short Training fields (IMMW-STF 316), IMMW Long Training Fields (IMMW-LTF 317), data field 318, and PE field 319 of the IMMW data PPDU 311 may be encoded using the wider signal bandwidth. By using an integer multiple of the minimum channel bandwidth (e.g., 20 MHz) for the IMMW-STF, IMMW-LTF, data and PE fields 316-319, the IMMW data PPDU 311 has a wider bandwidth that has good coexistence with devices operating with smaller bandwidth.

In the IMMW-SIG fields 315A-D, there are a number of signaling options. In one option, the IMMW SIG can specify two content channels in keeping with the definitions in the 802.11ax/be/bn protocols. In another option, the IMMW SIG can define independent encoding per subchannel with different content. In another option, the IMMW SIG can specify that the same content is encoded based on one subchannel and duplicated across all subchannels. In another option, all the IMMW SIG bits can be jointly modulated over all subchannels.

In the depicted design for the first preamble field format sequence 310 of the IMMW data PPDU 311, the structure of the duplicated PHY preamble field structures 312-315 enables the first tone plan 34 to re-use the legacy tone plan for sub-7 GHz L-STF/L-LTF field encoding and expand bandwidth through upclocking. As a result, the frequency domain encoding from the minimum bandwidth (e.g., 320 MHz) for the L-LTF field 312A through the IMMW SIG field 315A can be replicated for the other preamble field sequences 312B-315B, 312C-315C, 312D-315D. In addition, the second tone plan 35 that is applied to at least the IMMW STF field 316, IMMW LTF field 317, data field 318, and PE field 319 can be a wider bandwidth tone plan (e.g., 640/1280 MHz).

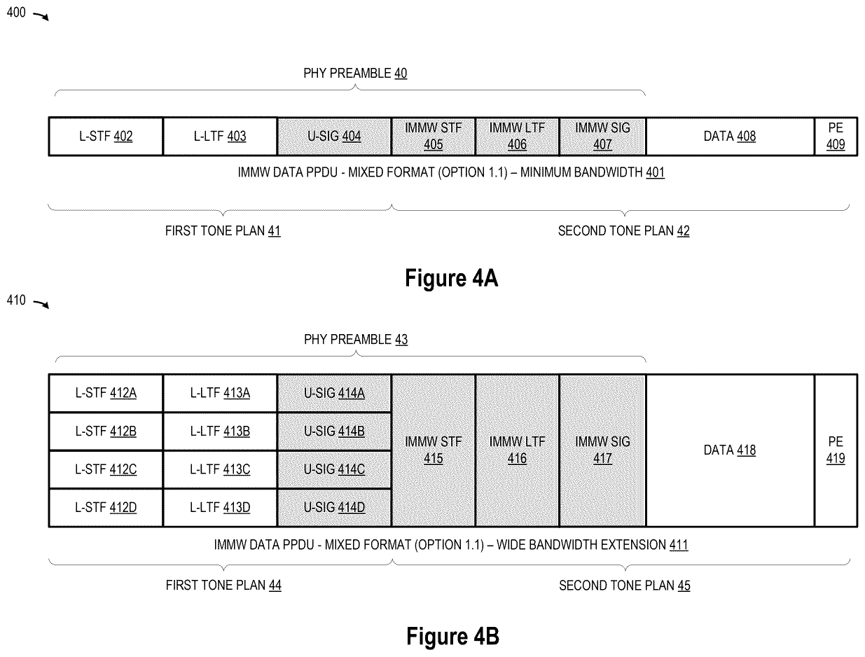

With the first preamble field format sequences 310, 320 illustrated in FIGS. 3A-B for the IMMW data PPDUs 301, 311, the IMMW signaling field (IMMW-SIG) is conveyed using the minimum bandwidth channel (e.g., 320 MHz) which is transmitted with the first (or legacy) tone plan 31, 34. However, the IMMW-SIG field may have a large amount of content that is difficult to signal using the first tone plan. To provide improved efficiency for conveying the IMMW signaling information with the second tone plan, the IMMW-SIG field may be placed after the IMMW-LTF field so that it is transmitted using the second tone plan. To illustrate an example of a preamble field format sequence for signaling the IMMW-SIG field with increased efficiency, reference is now made to FIG. 4A which illustrates a second preamble field format sequence 400 of an IMMW data PPDU 401 which is transmitted with a mixed format, minimum bandwidth signaling option. The second preamble field format 400 includes a second defined PHY preamble sequence 40 (L-STF/L-LTF/U-SIG/IMMW-STF/IMMW-LTF/IMMW-SIG) that is extendable to future versions of the IEEE 802.11 communication protocol without further increasing the complexity of auto-detection at the receiver from that of previous IEEE 802.11 communication protocols.

As depicted, the IMMW data PPDU 401 includes a PHY preamble portion 40 and a data and extension field portion 408-409. Instead of including a legacy signal subfield, the PHY preamble portion 40 includes an L-STF field 402, an L-LTF field 403, a U-SIG field 404, an IMMW-STF field 405, an IMMW-STF field 406, and an IMMW-SIF field 407. The data and extension field portion includes a data field 408 and a PE field 409. With the mixed format design, a first tone plan 41 is used to modulate and transmit the L-STF, L-LTF, and U-SIG fields 402-404, while a second tone plan 42 is used to modulate and transmit the IMMW-STF, IMMW-LTF, IMMW-SIG, data and PE fields 405-409. In selected embodiments, a postamble or training (TRN) field may optionally be appended after the data field 408 for use with providing end-of-packet beam refinement.

In a first legacy tone plan option, the first tone plan 41 may use 48 data subcarriers (tones) (52 data and pilot tones) to carry the information bits with a half-rate BCC error correction coding. In a second tone plan option, the first tone plan 41 may use 52 data subcarriers (tones) (56 data and pilot tones) to carry the information bits with a half-rate BCC error correction coding, in which case the L-LTF field 403 needs to add two-bits on each side of the sequence to make it compatible with the 56-tone plan, and the L-STF field 402 may also be extended to occupy 56 tones by adding one loaded tone to each side of the L-STF sequence.

With the location of the IMMW-SIG field 407 after the IMMW-STF and IMMW-LTF fields 405-406, some advance IMMW signaling information will need to be signaled ahead of the IMMW-STF and IMMW-LTF fields 405-406. In selected embodiments, this U-SIG field 404 may be encoded with advance IMMW signaling information, including but not limited to, the Nss/P size, LTF format in U-SIG, Number of IMMW-SIG, IMMW-SIG MCS

To provide additional details for an improved understanding of selected embodiments of the present disclosure, reference is now made to FIG. 4B which illustrates a second preamble field format sequence 410 of an IMMW data PPDU 411 which is transmitted with a mixed format, wide bandwidth signaling option. As depicted, the IMMW data PPDU 411 includes a second defined PHY preamble sequence 43 (L-STF/L-LTF/U-SIG/IMMW-STF/IMMW-LTF/IMMW-SIG) and a data and extension field portion 418-419. In particular, the disclosed PHY preamble sequence 43 includes three fields 412-414 that are duplicated over four minimum bandwidth channels (e.g., 20 MHz) of the wider channel bandwidth and three fields 415-417 that extend over the wider channel bandwidth (e.g. 160 MHz, 320 MHz, 640 MHz, 1280 MHz, etc.). The six fields of the PHY preamble sequence 43 are implemented as a plurality of preamble fields for each 20 MHz channel of the signal bandwidth (e.g., L-LTF 412A, L-LTF 413A, and U-SIG 414A) that are duplicated over the entire signal bandwidth, followed by three fields (IMMW-STF 415, IMMW-LTF 416, and IMMW-SIG 417) which extend over the wider signal bandwidth. In selected embodiments, “duplicated” may imply that the contents (e.g., data, information, bits, etc.) of each field for a 20 MHz channel are duplicated across the signal bandwidth and/or are the same for each corresponding field in other 20 MHz channels of the PPDU. For example, the contents of the first L-STF field 412A in the first or top 20 MHz channel of the IMMW data PPDU 411 may be repeated and/or the same as the contents of the L-STF fields 412B-D in the other 20 MHz channels.

In the depicted design for the second preamble field format sequence 410 of the IMMW data PPDU 411, the structure of the duplicated PHY preamble field structures 412-414 enables the first tone plan 44 to re-use the legacy tone plan for sub-7 GHz L-STF/L-LTF field encoding. As a result, the frequency domain encoding from the minimum bandwidth (e.g., 320 MHz) for the L-STF field 412A through the U-SIG field 414A can be replicated for the other preamble field sequences 412B-414B, 412C-414C, 412D-414D. In addition, the second tone plan 45 that is applied to the IMMW-STF field 415, IMMW-LTF field 416, IMMW-SIG field 417, data field 418, and PE field 419 can be a wider bandwidth tone plan (e.g., 640/1280 MHz).

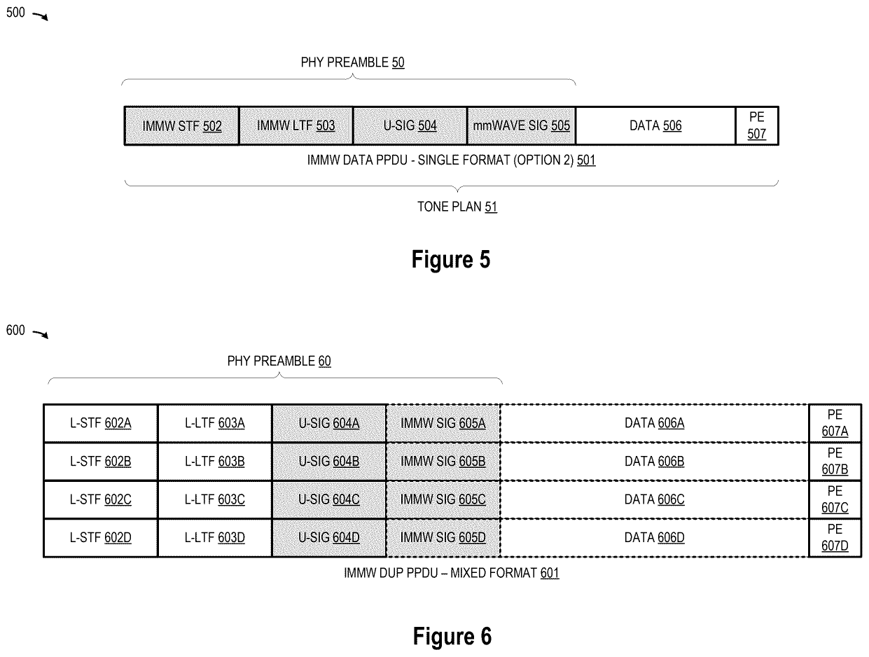

With the example mixed format sequences of the IMMW data PPDUs illustrated in FIGS. 4A-B and 5A-B for the IMMW data PPDUs, two different tone plans are applied to the legacy training fields (L-STF, L-LTF) and the IMMW training fields (IMMW-STF, IMMW-LTF). However, in light of the fact that the IMMW preamble does not have to be understandable by legacy standards devices, a more efficient PHY design can eliminate the requirement of having multiple sets of training fields by defining an IMMW PPDU signaling format with a single (or “green field”) format design where a single tone plan is used for the entire IMMW PPDU. To illustrate an example of an efficient preamble field format sequence which has a single set of IMMW training fields, reference is now made to FIG. 5 which illustrates a third preamble field format sequence 500 of an IMMW data PPDU 501 which is transmitted with a single or green field format, minimum bandwidth signaling option. The third preamble field format 500 includes a third defined PHY preamble sequence 50 (IMMW-STF/IMMW-LTF/U-SIG/mmWave-STF) that is extendable to future versions of the IEEE 802.11 communication protocol without further increasing the complexity of auto-detection at the receiver from that of previous IEEE 802.11 communication protocols.

As depicted, the IMMW data PPDU 501 includes a PHY preamble portion 50 and a data and extension field portion 506-507. Instead of including any legacy signal or training subfields, the PHY preamble portion 50 includes an IMMW-STF field 502, an IMMW-LTF field 503, a U-SIG field 504, and a mmWave SIG field 505. The data and extension field portion includes a data field 506 and a PE field 507. With the single format design, a single tone plan 51 is used to modulate and transmit all the fields of the IMMW data PPDU 502-507. In selected embodiments, a postamble or training (TRN) field may optionally be appended after the data field 408 for use with providing end-of-packet beam refinement. As a result of eliminating the legacy training fields, the IMMW data PPDU 501 includes a single training portion of IMMW training fields 502, 503, where the specific bit sequences in each field 502, 503 are bandwidth specific.

To enable interoperability among devices with different operating bandwidth, the IMMW protocol will include an IMMW duplicate (DUP) PPDU scheme for transmitting two (or more) identical copies of the same PSDU concurrently by duplicating the PSDU across multiple base bandwidth. Both the original and the duplicate PPDUs contain the exact same MAC payload (PSDU) and are generated using the same encoding and modulation parameters. Typically, the duplicate PPDU contains control frames and/or management frames.

To provide additional details for an improved understanding of selected embodiments of the present disclosure, reference is now made to FIG. 6 which illustrates a fourth preamble field format sequence 600 of an IMMW data PPDU 601 which is transmitted with a mixed format, wide bandwidth signaling option. As depicted, the IMMW data PPDU 601 includes a fourth defined PHY preamble sequence 60 (L-STF/L-LTF/U-SIG/IMMW-SIG) and a data and extension field portion 606-607 which are transmitted in the minimum bandwidth channel (e.g., L-STF 602A/L-LTF 603A/U-SIG 604A/IMMW-SIG 605A) and replicated in a plurality of additional minimum bandwidth channels (e.g., 602B-605B, 602C-605C, 602D-605D). In particular, the disclosed PHY preamble sequence 60 includes four fields 602-605 that are duplicated over four minimum bandwidth channels (e.g., 20 MHz) of the wider channel bandwidth. In similar fashion, the data and extension field portion 606-607 are duplicated over four minimum bandwidth channels (e.g., 20 MHz) of the wider channel bandwidth. As will be appreciated, the fourth preamble field format sequence 600 may be modified to improve compatibility by including an IMMW-STF field and IMMW-LTF field, after the IMMW-SIG fields 605A-D. In other embodiments, the fourth preamble field format sequence 600 may be modified to skip or omit the IMMW-SIG fields 605A-D if the first U-SIG field 604 conveys the required MAC control or management frame information. In other embodiments, the fourth preamble field format sequence 600 may be modified to skip or omit the data fields 606A-D if the required MAC control or management frame information can be conveyed in the IMMW-SIG fields 605A-D.

In the depicted design for the fourth preamble field format sequence 600 of the IMMW DUP PPDU 601 which is transmitted with a mixed format, wide bandwidth signaling option, the structure of the duplicated PHY preamble field structures 602-605 enables a first tone plan to be applied to the L-STF fields 602A-D, L-LTF fields 603A-D, and U-SIG fields 603A-D, while a second tone plan is applied to the IMMW-SIG fields 605A-D, data fields 606A-D, and PE fields 607A-D. As a result, the IMMW DUP PPDU 601 may be used as a MAC control frame or management frame that can be decoded by with devices having different bandwidths. Examples of such control frames include, but are not limited to a request to send (RTS) frame, a clear to send (CTS) frame, a block acknowledgment (BA) frame, or a Null Data Packet Announcement (NDPA) frame.

As will be appreciated, the depicted design for the fourth preamble field format sequence 600 of the IMMW DUP PPDU 601 may instead be transmitted with a single (or “green field”) format design whereby a first tone plan is applied to all of the PPDU fields 602-607. To illustrate the single format design, the legacy training fields (L-STF 602A-D, L-LTF 603A-D) may be renamed as IMMW training fields (IMMW-STF, IMMW-LTF). Additionally, the IMMW training fields may also be present before DATA field.

To maximize the signal power of PPDU transmissions in the challenging mmWave environment where the mmWave RF signal propagation loss is much higher, an antenna phase array is commonly adopted to boost the transmit power with directionality. The IMMW protocol will include an IMMW null data packet (NDP) PPDU scheme for supporting channel sounding and beamforming training without carrying any MAC-layer payload. The IMMW NDP PPDU structure is characterized by the replacement of a data field with one or more IMMW signal training fields that can be used for transmission of a Sector Level Sweep (SLS) PPDU, Beam Refinement Protocol (BRP) PPDU used with analog beam training, and/or a digital beamforming channel sounding PPDU.

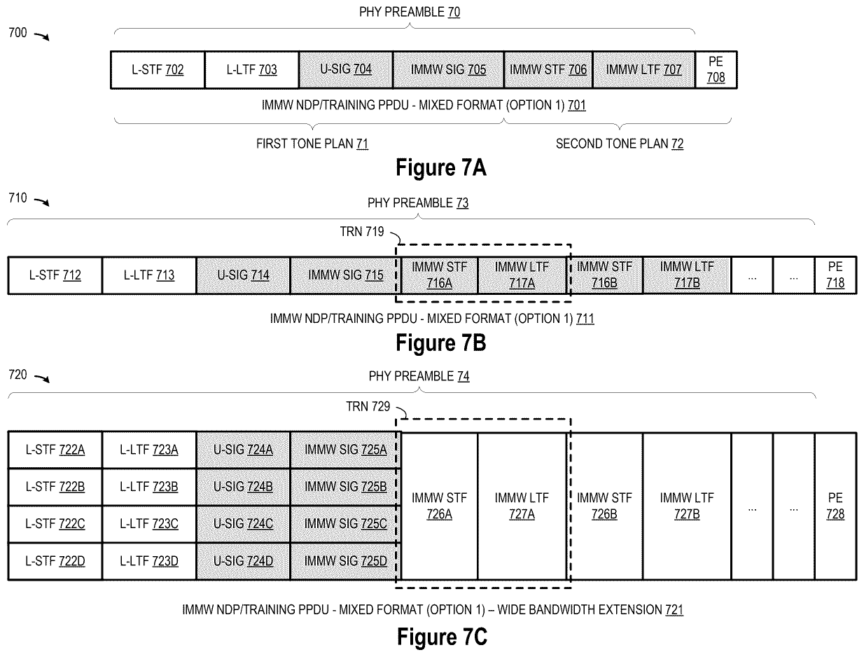

To provide additional details for an improved understanding of selected embodiments of the present disclosure, reference is now made to FIG. 7A which illustrates a fifth preamble field format sequence 700 of an IMMW NDP or training (TRN) PPDU 701 which is transmitted with a mixed format, minimum bandwidth signaling option. As depicted, the disclosed fifth preamble field format sequence 700 includes a PHY preamble portion 70 and a packet extension field portion 708. In particular, the IMMW NDP/TRN PPDU 701 includes a PHY preamble sequence 70 and a packet extension field 708 in the minimum bandwidth channel. However, instead of including a legacy signal field, the PHY preamble sequence 70 includes an L-STF field 702, an L-LTF field 703, a U-SIG field 704, an IMMW-SIG field 705, an IMMW-STF field 706, and an IMMW-SIF field 707. In addition, the IMMW NDP/TRN PPDU 701 does not include data symbols in a data field, but includes a PE field 708.

With the mixed format design, a first tone plan 71 is used to modulate and transmit the L-STF, L-LTF, U-SIG and IMMW-SIG fields 702-705, while a second tone plan 72 is used to modulate and transmit the IMMW-STF, IMMW-LTF, and PE fields 706-708. In selected embodiments, it will be appreciated that the IMMW-SIG field 705 may be placed after the IMMW-LTF field 706 so that it is transmitted using the second tone plan 72 for greater efficiency. As will be appreciated, the depicted design for the fifth preamble field format sequence 700 of the IMMW NDP/TRN PPDU 701 may instead be transmitted with a single (or “green field”) format design whereby a single tone plan is applied to all of the PPDU fields 702-708. To illustrate the single format design, the legacy training fields (L-STF 702, L-LTF 703) may be renamed as IMMW training fields (IMMW-STF, IMMW-LTF).

To provide additional details for an improved understanding of selected embodiments of the present disclosure, reference is now made to FIG. 7B which illustrates a sixth preamble field format sequence 710 of an IMMW NDP/TRN PPDU 711 which is transmitted with a mixed format, minimum bandwidth signaling option. As depicted, the disclosed sixth preamble field format sequence 710 includes a PHY preamble portion 73 and a packet extension field portion 718. In particular, the IMMW NDP/TRN PPDU 711 includes a PHY preamble sequence 73 and a packet extension field 718 in the minimum bandwidth channel. Instead of including a legacy signal field, the PHY preamble sequence 73 includes an L-STF field 712, an L-LTF field 713, a U-SIG field 714, an IMMW-SIG field 715, and at least one pair of IMMW training fields (e.g., IMMW-STF field 716A, IMMW-SIF field 717A) that may be repeated one or more times (e.g., IMMW-STF field 716B, IMMW-SIF field 717B). In addition, the IMMW NDP/TRN PPDU 711 does not include data symbols in a data field, but does include a PE field 718. As depicted, each pair of IMMW fields (e.g., IMMW-STF 716A, IMMW-LTF 717A) can include beamforming training (TRN) data (e.g., 719) so that the IMMW NDP/TRN PPDU 711 can be used to transmit multiple beamforming training fields for use with training different antenna beams.

With the mixed format design, a first tone plan may be used to modulate and transmit the L-STF, L-LTF, U-SIG and IMMW-SIG fields 712-715, while a second tone plan may be used to modulate and transmit the pair(s) of IMMW training fields and PE fields 716-718. In selected embodiments, it will be appreciated that the IMMW-SIG field 705 may be placed after the pair(s) of IMMW training fields so that it is transmitted using the second tone plan for greater efficiency. As will be appreciated, the depicted design for the sixth preamble field format sequence 710 of the IMMW NDP/TRN PPDU 711 may instead be transmitted with a single (or “green field”) format design whereby a single tone plan is applied to all of the PPDU fields 712-718. To illustrate the single format design, the legacy training fields (L-STF 712, L-LTF 713) may be renamed as IMMW training fields (IMMW-STF, IMMW-LTF).

To provide additional details for an improved understanding of selected embodiments of the present disclosure, reference is now made to FIG. 7C which illustrates a sixth preamble field format sequence 720 of an IMMW NDP/TRN PPDU 721 which is transmitted with a mixed format, wide bandwidth signaling option. As depicted, the disclosed sixth preamble field format sequence 720 includes a PHY preamble portion 74 and a packet extension field portion 728. In particular, the disclosed PHY preamble portion 74 includes four fields 722-725 that are duplicated over four minimum bandwidth channels (e.g., 320 MHz) of the wider channel bandwidth and one or more additional pairs of IMMW training fields 726-727 that extend over the wider channel bandwidth (e.g. 640 MHz, 1280 MHz, etc.). The fields of the PHY preamble sequence 74 are implemented as a plurality of preamble fields for each 20 MHz channel of the signal bandwidth (e.g., L-LTF 722A, L-LTF 723A, U-SIG 724A, IMMW-SIG 725A) that are duplicated over the entire signal bandwidth, followed by one or more additional pairs of IMMW training fields (IMMW-STF 726A, IMMW-LTF 727A, IMMW-STF 726B, IMMW-LTF 727B, etc.) which extend over the wider signal bandwidth. As depicted, each pair of IMMW fields (e.g., IMMW-STF 726A, IMMW-LTF 727A) can include beamforming training (TRN) data (e.g., 729) so that the IMMW NDP/TRN PPDU 721 can be used to transmit multiple beamforming training fields for use with training different antenna beams.

With the mixed format design, a first tone plan may be used to modulate and transmit the L-STF, L-LTF, U-SIG and IMMW-SIG fields 722-725, while a second tone plan may be used to modulate and transmit the pair(s) of IMMW training fields and PE fields 726-728. As will be appreciated, the depicted design for the sixth preamble field format sequence 720 of the IMMW NDP/TRN PPDU 721 may instead be transmitted with a single (or “green field”) format design whereby a single tone plan is applied to all of the PPDU fields 722-728. To illustrate the single format design, the legacy training fields (L-STF 722A-D, L-LTF 723A-D) may be renamed as IMMW training fields (IMMW-STF, IMMW-LTF).

The transmission range of an IMMW NDP PPDU can be significantly boosted by improving the receiving sensitivity of the legacy preamble portion of the PHY preamble, and the IMMW preamble portion of the PHY preamble is used to sweep multiple finer beams. This method leverages the best features of both the legacy and new IMMW signal structures, but must account for the power difference between the legacy preamble portion and the IMMW preamble portion in order to balance the sensitivity and range of the legacy preamble portion and the IMMW preamble portions of the PHY preamble.

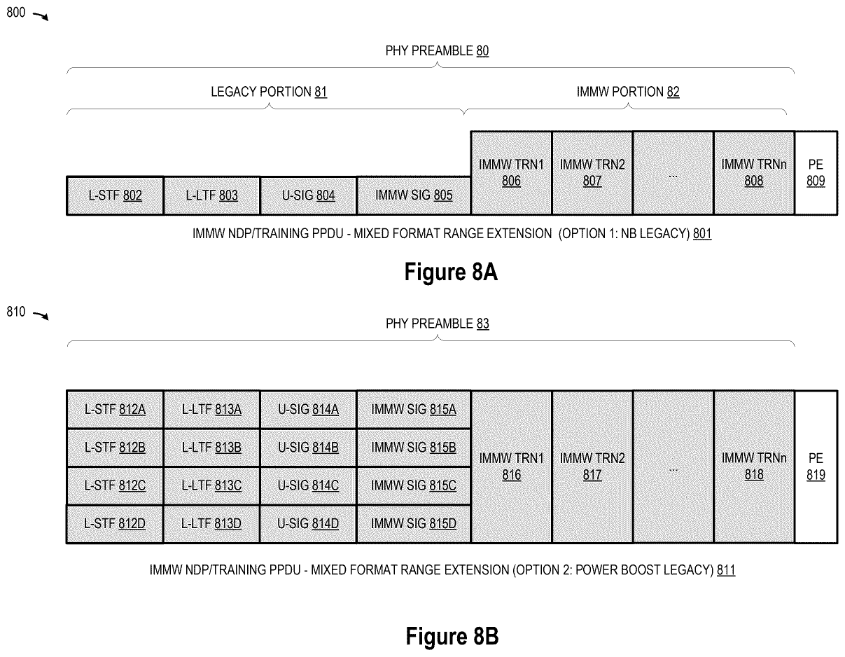

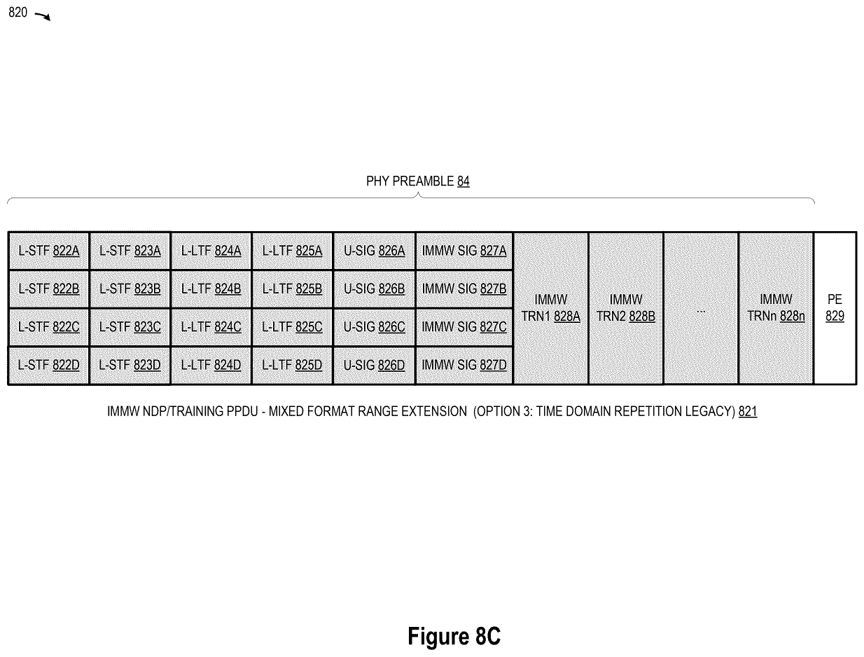

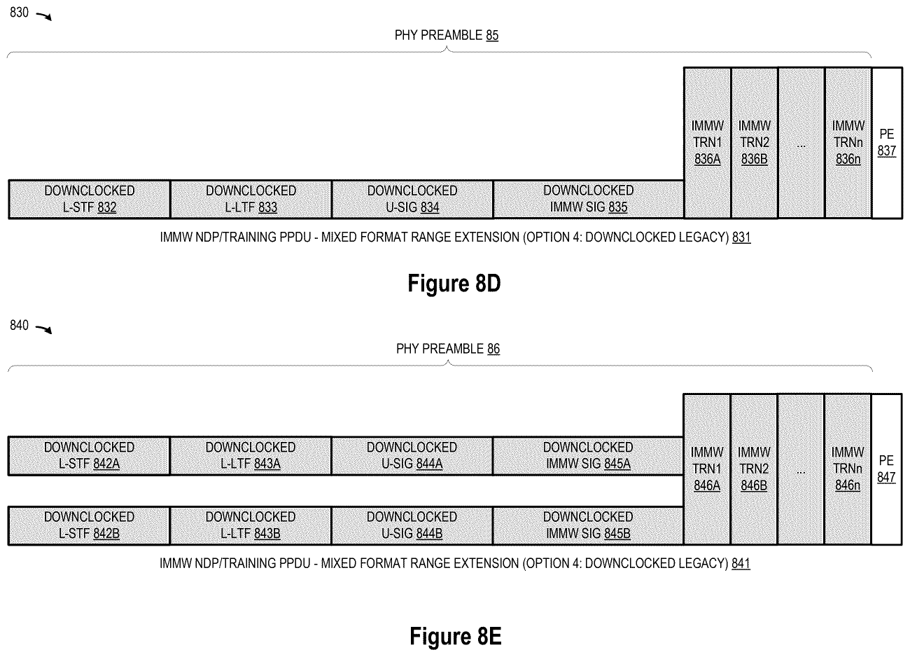

To provide additional details for an improved understanding of selected embodiments of the present disclosure, reference is now made to FIG. 8A which depicts a first option for balancing the sensitivity and range of the legacy preamble portion and the IMMW preamble portion by illustrating a seventh preamble field format sequence 800 of an IMMW NDP/TRN PPDU 801 which is transmitted with a mixed format, mixed bandwidth signaling option for use with beam refinement protocol (BRP) training. As depicted, the disclosed seventh preamble field format sequence 800 includes a PHY preamble portion 80 and a packet extension field portion 809. In particular, the PHY preamble sequence 80 includes a narrow band legacy portion 81 with an L-STF field 802, an L-LTF field 803, a U-SIG field 804, an IMMW-SIG field 805 which are transmitted in the minimum bandwidth channel. In addition, the PHY preamble sequence 80 includes an IMMW training portion 82 with one or more IMMW training fields 806-808 which are transmitted with the PE field portion 809 in a wider bandwidth channel. With the mixed format design, a first tone plan may be used to modulate and transmit the L-STF, L-LTF, U-SIG and IMMW-SIG fields 802-805, while a second tone plan may be used to modulate and transmit the IMMW-STF, IMMW-LTF, and PE fields 806-809. As will be appreciated, the depicted design for the seventh preamble field format sequence 800 of the IMMW NDP/TRN PPDU 801 may instead be transmitted with a single (or “green field”) format design whereby a single tone plan is applied to all of the PPDU fields 802-809, in which case the legacy training fields (L-STF 802, L-LTF 803) may be renamed as IMMW training fields (IMMW-STF, IMMW-LTF).

To provide additional details for an improved understanding of selected embodiments of the present disclosure, reference is now made to FIG. 8B which depicts a second option for balancing the sensitivity and range of the legacy preamble portion and the IMMW preamble portion by illustrating an eighth preamble field format sequence 810 of an IMMW NDP/TRN PPDU 811 which is transmitted with a mixed format, wide bandwidth signaling option which boosts the power of the legacy preamble portion for use with BRP training. As depicted, the disclosed eighth preamble field format sequence 810 includes a PHY preamble portion 83 and a packet extension field portion 810. In particular, the disclosed PHY preamble portion 83 includes four fields 812-815 that are duplicated over four minimum bandwidth channels (e.g., 320 MHz) of the wider channel bandwidth and one or more additional IMMW training fields 816-818 that extend over the wider channel bandwidth (e.g. 640 MHz, 1280 MHz, etc.). To provide a range extension mode, the fields of the PHY preamble sequence 83 are implemented as a plurality of preamble fields for each 20 MHz channel of the signal bandwidth (e.g., L-STF 812A, L-LTF 813A, U-SIG 814A, IMMW-SIG 815A) that are duplicated over the entire signal bandwidth, followed by one or more additional IMMW training fields (IMMW-TRN1 816, IMMW-TRN2 817, IMMW-TRNn 818, etc.) which extend over the wider signal bandwidth. As depicted, each IMMW training field 816-818 can include beamforming training data. With the eighth preamble field format sequence 810 including multiple copies of the legacy preamble fields (812A-815A, 812B-815B, 812C-815C, 812D-815D), the transmit power for the legacy preamble fields is boosted (e.g., by 3 dB) over the narrow band legacy portion 81 depicted in FIG. 8A, thereby improving the acquisition sensitivity for the IMMW NDP/TRN PPDU 811. As will be appreciated, the depicted design for the eighth preamble field format sequence 810 of the IMMW NDP/TRN PPDU 811 may instead be transmitted with a single (or “green field”) format design whereby a single tone plan is applied to all of the PPDU fields 812-819, in which case the legacy training fields (L-STF 812, L-LTF 813) may be renamed as IMMW training fields (IMMW-STF, IMMW-LTF).

As an alternative to boosting the power of the legacy preamble portion by duplicating the narrow band legacy fields as shown in FIG. 8B, another option is a time domain (TD) extension by repeating the legacy fields to allow the receiver to combine the repeated signal to improve the detection sensitivity of the legacy preamble portion for use with BRP training. To provide additional details for an improved understanding of selected embodiments of the present disclosure, reference is now made to FIG. 8C which depicts a third option for balancing the sensitivity and range of the legacy preamble portion and the IMMW preamble portion by illustrating a ninth preamble field format sequence 820 of an IMMW NDP/TRN PPDU 821 which is transmitted with a mixed format, wide bandwidth signaling option which boosts the power of the legacy preamble portion for use with BRP training. As depicted, the disclosed ninth preamble field format sequence 820 includes a PHY preamble portion 84 and a packet extension field portion 829, with duplicates of the L-STF and L-LTF fields in the PHY preamble portion 84. To provide a range extension mode, the disclosed PHY preamble portion 84 includes six fields 822-827 that are duplicated over four minimum bandwidth channels (e.g., 320 MHz) of the wider channel bandwidth and one or more additional IMMW training fields 828A-n that extend over the wider channel bandwidth (e.g. 640 MHz, 1280 MHz, etc.). The fields of the PHY preamble sequence 84 are implemented as a plurality of preamble fields for each 320 MHz channel of the signal bandwidth (e.g., L-STF 822A, L-STF 823A, L-LTF 824A, L-LTF 825A, U-SIG 826A, IMMW-SIG 827A) that are duplicated over the entire signal bandwidth, followed by one or more additional IMMW training fields (IMMW-TRN1 828A, IMMW-TRN2 828B, IMMW-TRNn 828n, etc.) which extend over the wider signal bandwidth. As depicted, each IMMW training field 826A-n can include beamforming training data. With the ninth preamble field format sequence 820 including multiple copies of the legacy preamble fields (822A-827A, 822B-827B, 822C-827C, 822D-827D), each of which includes duplicates of the L-STF and L-LTF fields, the transmit power for the legacy preamble fields is further boosted in the time domain over the narrow band legacy portion 81 depicted in FIG. 8A, thereby improving the acquisition sensitivity for the IMMW NDP/TRN PPDU 821. As will be appreciated, the depicted design for the ninth preamble field format sequence 820 of the IMMW NDP/TRN PPDU 821 may instead be transmitted with a single (or “green field”) format design whereby a single tone plan is applied to all of the PPDU fields 822-829, in which case the legacy training fields (L-STF 822, L-LTF 823) may be renamed as IMMW training fields (IMMW-STF, IMMW-LTF).

As an alternative to improve the detection sensitivity of the legacy preamble portion by repeating the legacy fields as shown in FIG. 8C, another option is to downclock the legacy preamble portion using a lower clock rate than the IMMW preamble portion for use with BRP training. To provide additional details for an improved understanding of selected embodiments of the present disclosure, reference is now made to FIG. 8D which depicts a fourth option for balancing the sensitivity and range of the legacy preamble portion and the IMMW preamble portion by illustrating a tenth preamble field format sequence 830 of an IMMW NDP/TRN PPDU 831 which is transmitted with a mixed format, minimum bandwidth signaling option for a downclocked legacy portion which boosts the power of the legacy preamble portion for use with BRP training. As depicted, the disclosed tenth preamble field format sequence 830 includes a PHY preamble portion 85 and a packet extension field portion 837, with the downclocked legacy preamble fields in the PHY preamble portion 85. In particular, a range extension mode is provided by designing the PHY preamble portion 85 to include a narrow band legacy portion with a downclocked L-STF field 832, a downclocked L-LTF field 833, a downclocked U-SIG field 834, and a downclocked IMMW-SIG field 835 which are transmitted in the minimum bandwidth channel. In addition, the PHY preamble portion 85 includes one or more additional IMMW training fields 836A-n and a PE field 837 that are upclocked and that extend over the wider channel bandwidth (e.g. 160 MHz, 320 MHz, 640 MHz, 1280 MHz, etc.). In an example embodiment, the legacy preamble fields (L-STF to U-SIG) have 1/N lower clock rate than IMMW portion. In another example embodiment, the legacy preamble fields (L-STF to IMMW-SIG) have 1/N lower clock rate than the IMMW preamble portion. As depicted, each of the IMMW training fields 836A-n can include beamforming training symbols. With the tenth preamble field format sequence 830 including downclocked legacy preamble fields (832-835), higher per-tone transmit power is achieved for the legacy preamble fields, thereby increasing the detection range for the IMMW NDP/TRN PPDU 831. As will be appreciated, the depicted design for the tenth preamble field format sequence 830 of the IMMW NDP/TRN PPDU 831 may instead be transmitted with a single (or “green field”) format design whereby a single tone plan is applied to all of the PPDU fields 832-837, in which case the legacy training fields (downclocked L-STF 832, downclocked L-LTF 833) may be renamed as IMMW training fields (downclocked IMMW-STF, downclocked IMMW-LTF).

To provide additional details for an improved understanding of selected embodiments of the present disclosure, reference is now made to FIG. 8E which depicts a fifth option for balancing the sensitivity and range of the legacy preamble portion and the IMMW preamble portion by illustrating an eleventh preamble field format sequence 840 of an IMMW NDP/TRN PPDU 841 which is transmitted with a mixed format, multiple minimum bandwidth signaling option for a downclocked legacy portion which boosts the power of the legacy preamble portion for use with BRP training. As depicted, the disclosed eleventh preamble field format sequence 840 includes a PHY preamble portion 86 and a packet extension field portion 847, with the downclocked legacy preamble fields in the PHY preamble portion 86. To provide a range extension mode, the PHY preamble portion 86 includes a narrow band legacy portion with a first downclocked preamble sequence (downclocked L-STF, L-LTF, U-SIG, and IMMW-SIG 842A-845A) and a second downclocked preamble sequence (downclocked L-STF, L-LTF, U-SIG, and IMMW-SIG 842B-845B), each of which is transmitted in the minimum bandwidth channel. In addition, the PHY preamble portion 86 includes one or more additional IMMW training fields 846A-n and a PE field 847 that are upclocked and that extend over the wider channel bandwidth (e.g. 160 MHz, 320 MHz, 640 MHz, 1280 MHz, etc.). In an example embodiment, the legacy preamble fields (L-STF to U-SIG) have 1/N lower clock rate than IMMW portion. In another example embodiment, the legacy preamble fields (L-STF to IMMW-SIG) have 1/N lower clock rate than the IMMW preamble portion. As depicted, each of the IMMW training fields 846A-n can include beamforming training symbols. With the eleventh preamble field format sequence 840 including downclocked legacy preamble fields (842-845), higher per-tone transmit power is achieved for the legacy preamble fields, thereby increasing the detection range for the IMMW NDP/TRN PPDU 841. As will be appreciated, the depicted design for the eleventh preamble field format sequence 840 of the IMMW NDP/TRN PPDU 841 may instead be transmitted with a single (or “green field”) format design whereby a single tone plan is applied to all of the PPDU fields 842-847, in which case the legacy training fields (downclocked L-STF 842, downclocked L-LTF 843) may be renamed as IMMW training fields (downclocked IMMW-STF, downclocked IMMW-LTF).

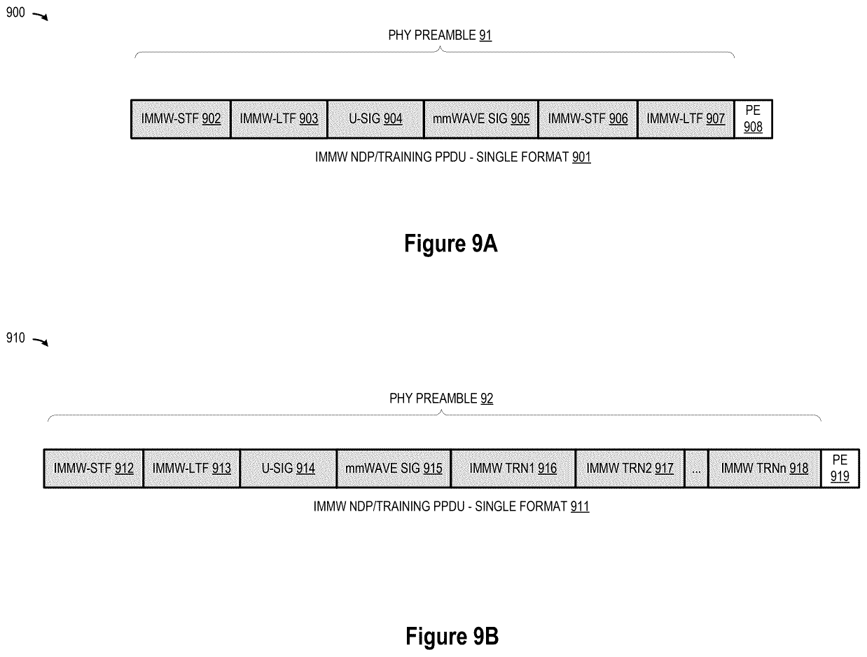

With the example mixed format sequences of the IMMW NPP/TRN PPDUs illustrated in FIGS. 8A-E, two different tone plans are applied to the legacy training fields (L-STF, L-LTF) and the IMMW training fields (IMMW-STF, IMMW-LTF). However, since the IMMW preamble does not have to be understandable by legacy standards devices, a more efficient PHY design can eliminate the requirement of having multiple sets of training fields by defining an IMMW NDP/TRN PPDU signaling format with a single (or “green field”) format design where a single tone plan is used for the entire IMMW NDP/TRN PPDU. To illustrate an example of an efficient preamble field format sequence which has only IMMW training fields, reference is now made to FIG. 9A which illustrates a twelfth preamble field format sequence 900 of an IMMW NDP/TRN PPDU 901 which is transmitted with a single or green field format, minimum bandwidth signaling option. As depicted, the twelfth preamble field format sequence 900 includes a PHY preamble portion 91 and a packet extension field portion 908. Instead of including any legacy signal or training subfields, the PHY preamble portion 91 includes an IMMW-STF field 902, an IMMW-LTF field 903, a U-SIG field 904, a mmWave SIG field 905, an additional IMMW-STF field 906, and an additional IMMW-LTF field 907. In addition, the IMMW NDP/TRN PPDU 901 does not include data symbols in a data field, but includes a PE field 908. With the single format design, a single tone plan is used to modulate and transmit all of the IMMW NDP/TRN PPDU fields 902-908. As a result of eliminating the legacy training fields, the IMMW data PPDU 901 includes a single training portion of IMMW training fields 902, 903, where the specific bit sequences in each field 902, 903 are bandwidth specific. In addition, the IMMW data PPDU 901 includes additional IMMW-STF field 906 and additional IMMW-LTF field 907 can be used to convey a training field for use with BRP training. In selected embodiments, the additional IMMW-STF field 906 and additional IMMW-LTF field 907 can be removed from the IMMW NDP/TRN PPDU 901 so that the PE field 908 directly follows the mmWave SIG field 905.

To illustrate an example of an efficient preamble field format sequence which has a single set of IMMW training fields, reference is now made to FIG. 9B which illustrates a thirteenth preamble field format sequence 910 of an IMMW NDP/TRN PPDU 911 which is transmitted with a single or green field format, minimum bandwidth signaling option. As depicted, the thirteenth preamble field format sequence 910 includes a PHY preamble portion 92 and a packet extension field portion 919. Instead of including any legacy signal or training subfields, the PHY preamble portion 92 includes an IMMW-STF field 912, an IMMW-LTF field 913, a U-SIG field 914, a mmWave SIG field 915, and one or more additional IMMW training fields (IMMW-TRN1 916, IMMW-TRN2 917, IMMW-TRNn 918, etc.), each of which is formed with additional IMMW training fields (IMMW-STF/IMMW-LTF). In addition, the IMMW NDP/TRN PPDU 911 does not include data symbols in a data field, but does include a PE field 919. With the single format design, a single tone plan is used to modulate and transmit all of the IMMW NDP/TRN PPDU fields 912-919. As a result of eliminating the legacy training fields, the IMMW data PPDU 911 includes a single training portion of IMMW training fields 912, 913, where the specific bit sequences in each field 912, 913 are bandwidth specific.

As described hereinabove, the mixed format and single format designs for the IMMW data PPDU, IMMW DUP PPDU, and IMMW NDP PPDU may be provided with an efficient PHY preamble portion by replacing the length subfield that is defined in previous protocols with information that is encoded in the universal signal field (U-SIG) and/or IMMW signal field (IMMW SIG). However, there are other options disclosed herein for designing the IMMW data PPDU, IMMW DUP PPDU, and IMMW NDP PPDU with a PHY preamble portion having more backward compatibility by retaining the legacy signal fields (L-SIG and RL-SIG) and/or by replacing the length field that is defined in previous protocols with information that is encoded in the universal signal field (U-SIG) and/or IMMW signal field (IMMW SIG).

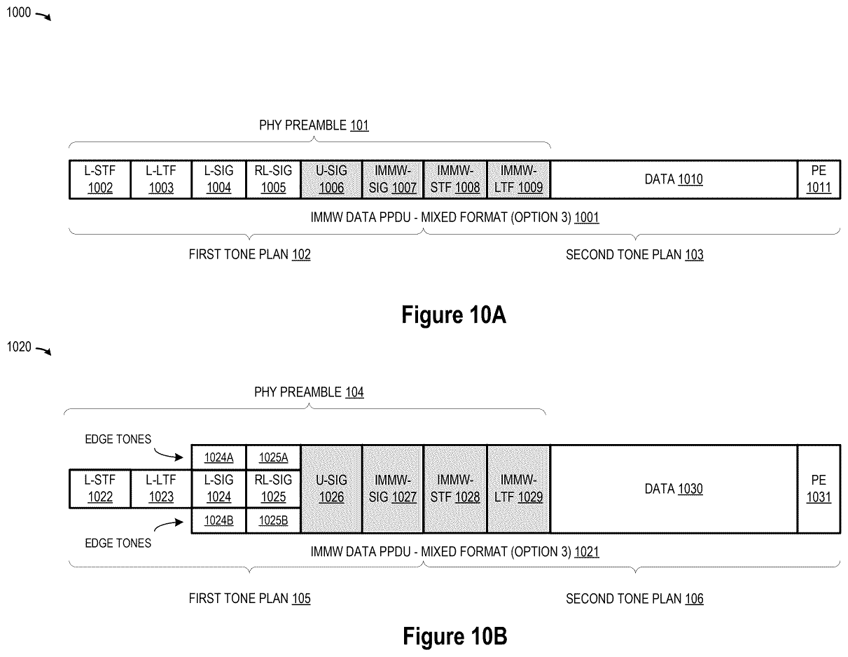

To provide additional details for an improved understanding of selected embodiments of the present disclosure, reference is now made to FIG. 10A which illustrates a fourteenth preamble field format sequence 1000 of an IMMW data PPDU 1001 which is transmitted with a mixed format, minimum bandwidth signaling option. As depicted, the fourteenth preamble field format sequence 1000 includes a PHY preamble portion 101 and a data and extension field portion 1010-1011. The fourteenth preamble field format 1000 includes a first defined PHY preamble sequence 101 (L-STF/L-LTF/L-SIG/RL-SIG/U-SIG/IMMW-SIG/IMMW-STF/IMMW-LTF). In particular, the PHY preamble sequence 101 includes an L-STF field 1002, an L-LTF field 1003, an L-SIG field 1004, an RL-SIG field 1005, a U-SIG field 1006, an IMMW-SIG field 1007, an IMMW-STF field 1008, and an IMMW-LTF field 1009 which are transmitted in the minimum bandwidth channel. In addition, the IMMW data PPDU 1001 includes a data field 1010 and a PE field 1011 which are transmitted in the minimum bandwidth channel. By retaining the legacy signal fields (L-SIG and RL-SIG), the PHY preamble portion 101 has improved backward compatibility by retaining the sequence of the preamble fields from L-STF to U-SIG. However, the U-SIG field 1006 may be a modified universal signaling field U-SIG 1006 which includes CRC code which is computed based on the bits from the retained legacy signal fields L-SIG 1004 and RL-SIG 1005 and from the U-SIG field 1006. As a result, the legacy signal fields will have better protection from the CRC code in the modified U-SIG field 1006, as compared to the legacy signal field which had poor protection from its limited coding and parity check. In the retained L-SIG field 1004, the 4-bit Rate field can be reserved or repurposed for other signaling. In addition, the 1-bit Parity bit from the retained L-SIG field 1004 can also be reserved or repurposed. In this disclosure, the modified U-SIG field 1006 can be a single symbol which contains only version independent information or subfields. With a mixed format design for the IMMW data PPDU 1011, a first tone plan 102 may be used to modulate and transmit the L-STF through IMMW-SIG fields 1002-1007, while a second tone plan 103 may be used to modulate and transmit the IMMW-STF through PE fields 1008-1011. Alternatively, with a single format design for the IMMW Data PPDU 1011, a single (or “green field”) tone plan may be applied to all of the PPDU fields 1002-1011, in which case the legacy training fields (L-STF 1002, L-LTF 1003) may be renamed as IMMW training fields (IMMW-STF, IMMW-LTF).

To provide additional details for an improved understanding of selected embodiments of the present disclosure, reference is now made to FIG. 10B which illustrates a fifteenth preamble field format sequence 1020 of an IMMW data PPDU 1021 which is transmitted with a mixed format, mixed bandwidth signaling option. As depicted, the disclosed fifteenth preamble field format sequence 1020 includes a PHY preamble portion 104 and a data and extension field portion 1030-1031. In particular, the PHY preamble sequence 104 includes a narrow band legacy portion with an L-STF field 1022, an L-LTF field 1023, an L-SIG field 1024, and an RL-SIG field 1025, and also includes an IMMW portion with a U-SIG field 1026, an IMMW-SIG field 1027, an IMMW-STF field 1028, and an IMMW-LTF field 1029 which are transmitted in a wider bandwidth channel. In addition, the IMMW data PPDU 1021 includes a data field 1030 and a PE field 1031 which are transmitted in the wider bandwidth channel. In this arrangement, one or more of the legacy signal fields (L-SIG and RL-SIG) 1024, 1025 may be jointly encoded with the U-SIG field 1026. For example, the U-SIG field 1026 may include CRC code which is computed based on the bits from the retained legacy signal fields L-SIG 1024 and RL-SIG 1025 and from the U-SIG field 1026. In order for the U-SIG field 1026 to reuse the 56-tone plan, a plurality of edge tones 1024A/B, 1025A/B should be added to the narrowband L-SIG field 1024 and RL-SIG field 1025. For example, the L-SIG field 1024 may have four edge tones by including two edge tones 1024A, 1024B on each side with pre-defined values to perform channel estimation. Similarly, the RL-SIG field 1025 may have four edge tones by including two edge tones 1025A, 1025B on each side with pre-defined values to perform channel estimation. In such embodiments, the legacy signal fields L-SIG 1024 and RL-SIG 1025 may be labeled as a U-SIG-1 field with a 56 tone plan where the four edge tones 1024A/B, 1025A/B are used for channel estimation. With a mixed format design for the IMMW data PPDU 1021, a first tone plan 105 may be used to modulate and transmit the L-STF through IMMW-SIG fields 1022-1027, while a second tone plan 106 may be used to modulate and transmit the IMMW-STF through PE fields 1028-1031. Alternatively, with a single format design for the IMMW Data PPDU 1021, a single (or “green field”) tone plan may be applied to all of the PPDU fields 1022-1031, in which case the legacy training fields (L-STF 1022, L-LTF 1023) may be renamed as IMMW training fields (IMMW-STF, IMMW-LTF).

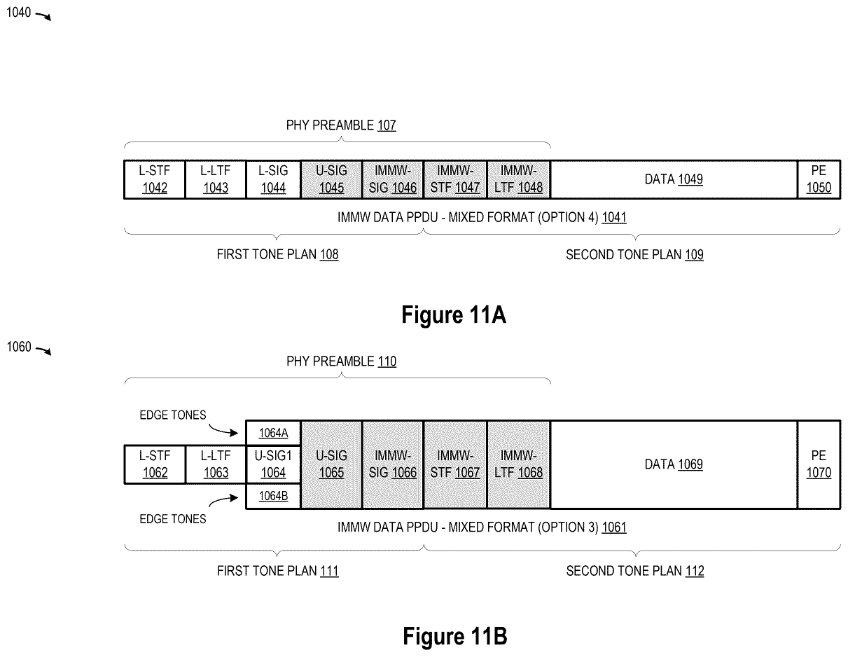

To provide additional details for an improved understanding of selected embodiments of the present disclosure, reference is now made to FIG. 11A which illustrates a sixteenth preamble field format sequence 1040 of an IMMW data PPDU 1041 which is transmitted with a mixed format, minimum bandwidth signaling option. As depicted, the sixteenth preamble field format sequence 1040 includes a PHY preamble portion 107 and a data and extension field portion 1049-1050. The sixteenth preamble field format sequence 1040 includes a first defined PHY preamble sequence 107 (L-STF/L-LTF/L-SIG/U-SIG/IMMW-SIG/IMMW-STF/IMMW-LTF) wherein the L-SIG field is retained but the RL-SIG field has been removed. In particular, the PHY preamble sequence 107 includes an L-STF field 1042, an L-LTF field 1043, an L-SIG field 1044, a U-SIG field 1045, an IMMW-SIG field 1046, an IMMW-STF field 1047, and an IMMW-LTF field 1048 which are transmitted in the minimum bandwidth channel. In addition, the IMMW data PPDU 1041 includes a data field 1049 and a PE field 1050 which are transmitted in the minimum bandwidth channel. By retaining the legacy signal field L-SIG, the PHY preamble portion 107 has improved backward compatibility. In addition, the U-SIG field 1006 may include a CRC code which is computed based on the bits from the retained legacy signal fields L-SIG 1044 and the U-SIG field 1045. As a result, the legacy signal field will have better protection from the CRC code in the modified U-SIG field 1045. With a mixed format design for the IMMW data PPDU 1041, a first tone plan 108 may be used to modulate and transmit the L-STF through IMMW-SIG fields 1042-1046, while a second tone plan 109 may be used to modulate and transmit the IMMW-STF through PE fields 1047-1050. Alternatively, with a single format design for the IMMW Data PPDU 1041, a single (or “green field”) tone plan may be applied to all of the PPDU fields 1042-1050, in which case the legacy training fields (L-STF 1042, L-LTF 1043) may be renamed as IMMW training fields (IMMW-STF, IMMW-LTF).

To provide additional details for an improved understanding of selected embodiments of the present disclosure, reference is now made to FIG. 11B which illustrates a seventeenth preamble field format sequence 1060 of an IMMW data PPDU 1061 which is transmitted with a mixed format, mixed bandwidth signaling option. As depicted, the disclosed seventeenth preamble field format sequence 1060 includes a PHY preamble portion 110 and a data and extension field portion 1069-1070. In particular, the PHY preamble sequence 110 includes a narrow band legacy portion with an L-STF field 1062, an L-LTF field 1063, and a U-SIG1 field 1064, and also includes a IMMW portion with a U-SIG field 1065, an IMMW-SIG field 1066, an IMMW-STF field 1067, and an IMMW-LTF field 1068 which are transmitted in a wider bandwidth channel. In addition, the IMMW data PPDU 1061 includes a data field 1069 and a PE field 1070 which are transmitted in the wider bandwidth channel. In this arrangement, the U-SIG1 field 1064 may contain the legacy LENGTH field and may be jointly encoded with the U-SIG field 1065. For example, the U-SIG field 1026 may include CRC code which is computed based on the bits from the U-SIG1 field 1064 and from the U-SIG field 1065. In order for the U-SIG field 1065 to reuse the 56-tone plan, a plurality of edge tones 1064A/B should be added to the U-SIG1 field 1064. For example, the U-SIG1 field 1064 may have four edge tones by including two edge tones 1064A, 1064B on each side with pre-defined values to perform channel estimation. With a mixed format design for the IMMW data PPDU 1061, a first tone plan 111 may be used to modulate and transmit the L-STF through IMMW-SIG fields 1062-1066, while a second tone plan 112 may be used to modulate and transmit the IMMW-STF through PE fields 1067-1079. Alternatively, with a single format design for the IMMW Data PPDU 1061, a single (or “green field”) tone plan may be applied to all of the PPDU fields 1062-1070, in which case the legacy training fields (L-STF 1062, L-LTF 1063) may be renamed as IMMW training fields (IMMW-STF, IMMW-LTF).

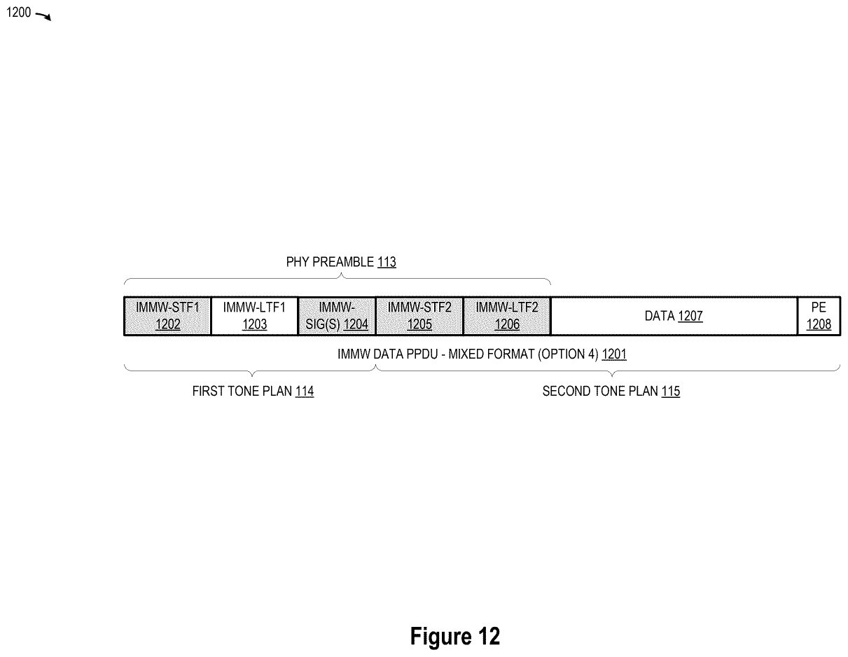

To provide additional details for an improved understanding of selected embodiments of the present disclosure, reference is now made to FIG. 12 which illustrates an eighteenth preamble field format sequence 1200 of an IMMW data PPDU 1201 which is transmitted with a unified format. As depicted, the disclosed eighteenth preamble field format sequence 1200 includes a PHY preamble portion 113 and a data and extension field portion 1207-1208. In particular, the PHY preamble sequence 113 includes a first IMMW STF signal field (IMMW-STF1) 1202, a first IMMW LTF signal field (IMMW-LTF1) 1203, one or more IMMW signal fields (IMMW-SIG(s)) 1204, an additional IMMW STF signal field (IMMW-STF2) 1205, and an additional IMMW LTF signal field (IMMW IMMW-LTF2) 1206, each of which is transmitted in the minimum bandwidth channel. In addition, the IMMW data PPDU 1201 includes a data field 1207 and a PE field 1208 which are transmitted in the narrow bandwidth channel. In this arrangement, the first IMMW STF signal field (IMMW-STF1) 1202 can be used to implement an IMMW STF function or a legacy STF function. IMMW STF can be a repeated legacy STF to provide more time for initial IMMW PPDU acquisition. In addition, the additional IMMW LTF signal field (IMMW IMMW-LTF2) 1206 can be used to implement an IMMW LTF function. In addition, the one or more IMMW signal fields (IMMW-SIG(s)) 1204 can be used to implement the universal signal (U-SIG) function and an IMMW signal (IMMW-SIG) function. With a mixed format design for the IMMW data PPDU 1201, a first tone plan 114 may be used to modulate and transmit the IMMW-STF1 through IMMW-SIG(s) fields 1202-1204, while a second tone plan 115 may be used to modulate and transmit the IMMW-STF2 through PE fields 1205-1208. Alternatively, with a single format design for the IMMW Data PPDU 1201, a single (or “green field”) tone plan may be applied to all of the PPDU fields 1202-1208.

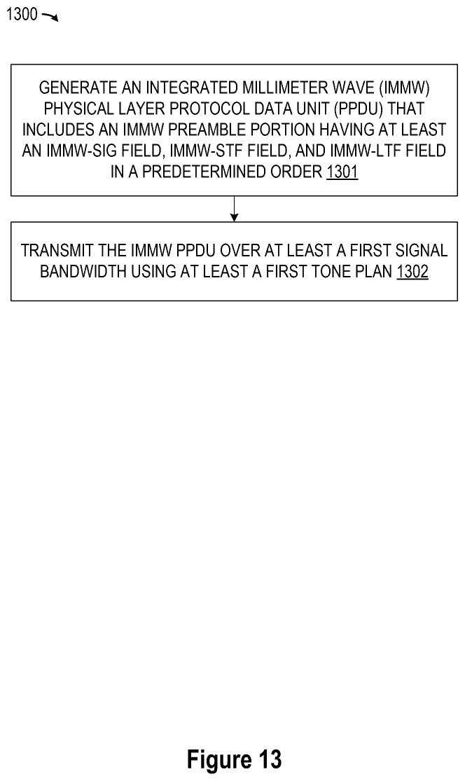

To provide additional details for an improved understanding of selected embodiments of the present disclosure, reference is now made to FIG. 13 which depicts an exemplary logic flow diagram 1200 to illustrate the operation of a wireless communication station (STA) device which uses an IMMW PPDU signaling procedure. The method 1300 may be implemented by a transmitter STA 11 or receiver STA 21 having a structure such as described with reference to FIG. 1, though the method 1300 may also be implemented by an AP or non-AP STA having a suitable structure different than illustrated in FIG. 1.

In various embodiments, the method 1300 is utilized in connection with any of the transmission sequences and data unit formats discussed in connection with any of FIGS. 2-12 and/or in connection with any of the techniques discussed above.

At step 1301, a first STA device (e.g., AP 11) generates an IMMW PPDU that includes an IMMW preamble portion having at least an IMMW-SIG field, IMMW-STF field, and IMMW-LTF field in a predetermined order or sequence. As described hereinabove, the IMMW preamble portion may include a first IMMW-SIG, IMMW-STF, IMMW-LTF sequence. Alternatively, the IMMW preamble portion may include a second IMMW-STF, IMMW-LTF, IMMW-SIG sequence. In addition, the IMMW PPDU may include a U-SIG field and a legacy preamble portion having at least a L-STF field and/or L-LTF field. As described hereinabove, the IMMW PPDU can be generated as an IMMW data PPDU, an IMMW DUP PPDU, or an IMMW NDP PPDU.

At step 1302, the first STA device transmits the IMMW PPDU over at least a first signal bandwidth channel to a second STA device using at least a first tone plan for the IMMW PPDU. As described hereinabove, the IMMW PPDU can be transmitted over a minimum signal bandwidth channel, over a wider signal bandwidth channel, or over a mixed signal bandwidth channel. In addition or in the alternative, the IMMW PPDU can be transmitted using a single tone plan that is used for all fields of the IMMW PPDU, or can be transmitted using a first tone plan for a first portion of the IMMW PPDU and using a second tone plan for a final portion of the IMMW PPDU.

In accordance with the present disclosure, there is provided a method of generating an efficient and future proof IMMW PPDU. In selected embodiments, the method generates the IMMW PPDU with a mixed preamble format that includes a legacy preamble (LSTF, LLTF), U-SIG, and IMMW preamble. In selected embodiments, the IMMW preamble includes a first sequence of fields, IMMW-SIG, IMMW-STF, IMMW-LTF. In other selected embodiments, the IMMW preamble includes a second sequence of fields, IMMW-STF, IMMW-LTF, IMMW-SIG. In other selected embodiments, the method generates the IMMW PPDU with a green field format preamble that includes only the IMMW-STF field, the IMMW-LTF field, and the IMMW-SIG field in a predetermined order, but does not include the legacy preamble fields (LSTF, LLTF). In selected embodiments, the method generates the IMMW PPDU as an IMMW DUP PPDU that is a duplication of a base bandwidth PPDU to transmit control packet to STAs with different bandwidths. In other selected embodiments, the method generates the IMMW PPDU as an IMMW NDP PPDU which is a single user (SU) PPDU without data portion. In other selected embodiments, the method generates the IMMW PPDU as an IMMW NDP PPDU that may include multiple training (TRN) field to serve as BRP training PPDU. In such embodiments, the IMWW NDP PPDU may have an range extension mode to bridge the SNR gap between SLS best beam to BRP best beam.

In accordance with the present disclosure, there is also provided a method of generating an efficient and future proof IMMW PPDU which retains a legacy L-SIG field and/or legacy RL-SIG field which precedes the U-SIG field. In selected embodiments, the method generates the IMMW PPDU to include four edge tones for the L-SIG field are used for channel estimation. In other selected embodiments, the method generates the IMMW PPDU to compute the U-SIG CRC is based on content of the L-SIG field and the U-SIG field. In other selected embodiments, the method generates the IMMW PPDU to reserve or redefine the LENGH bits from the L-SIG field. In other selected embodiments, the method generates the IMMW PPDU to jointly encode the content of the L-SIG field and the U-SIG field. In such embodiments, the method generates the IMMW PPDU to reserve or redefine the TAIL bits from the L-SIG field. In other selected embodiments, the method generates the IMMW PPDU to generate the U-SIG field to include only one symbol which contains version-independent information only.

By now it should be appreciated that there has been provided an apparatus, method, and system for operating a wireless personal area network in accordance with IEEE 802.11 protocol in a millimeter-wave frequency band using orthogonal frequency domain multiplexing (OFDM). In the disclosed method, a first STA device generates an Integrated Millimeter Wave (IMMW) physical layer protocol data unit (PPDU) which includes a first IMMW preamble portion and an IMMW signaling (SIG) field, and which also includes a second IMMW preamble portion. In selected embodiments, the first IMMW preamble portion may also include a legacy preamble portion having a legacy short training field (L-STF) and a legacy long training field (L-LTF) positioned in front of the SIG field. In other selected embodiments, the IMMW SIG field may also include a universal signaling (U-SIG) field which comprises version independent information bits, and additional IMMW-SIG subfield(s) carrying user information or training beam information. In such embodiments, the U-SIG field may encode a duration sub-field. In selected embodiments, the second IMMW preamble portion may include an IMMW-STF field and an IMMW-LTF field. In other selected embodiments, the second IMMW preamble portion may include an IMMW-STF field, an IMMW-LTF field, and an IMMW-SIG field. In selected embodiments, generating the IMMW PPDU may also include generating a legacy signal field in the first IMMW preamble portion. In such embodiments, the legacy signal field may include four edge tones that are used for channel estimation. In other such embodiments, the U-SIG field may include a Cyclic Redundancy Check (CRC) value that is computed from content contained in the legacy signal field and content contained in the U-SIG field. In other such embodiments, the legacy signal field may include a length subfield and one or more reserved fields. In other such embodiments, content from the legacy signal field is jointly encoded with content from the U-SIG field. In other such embodiments, the U-SIG field has one symbol containing version-independent information. In such embodiments, a SIGNAL TAIL subfield from the legacy signal field is redefined. In selected embodiments, the IMMW PPDU may be an IMMW data PPDU which includes a data field positioned after the second IMMW preamble portion. In other selected embodiments, the IMMW PPDU may be an IMMW duplicate PPDU that is a duplication of a base bandwidth PPDU to transmit a control packet to one or more additional STAs with different bandwidths. In other selected embodiments, the IMMW PPDU may be an IMMW null data packet (NDP) PPDU that is a single user PPDU that does not include a data field. In other selected embodiments, the IMMW PPDU may be an IMMW null data packet (NDP) PPDU that comprises multiple training fields for use with beam refinement protocol (BRP) training. In selected embodiments, the first IMMW preamble portion uses a smaller bandwidth than the second IMMW preamble portion. In other selected embodiments, the first IMMW preamble portion has longer duration than that of the single user PPDU. In addition, the disclosed method transmits the IMMW PPDU over at least a first signal bandwidth using at least a first tone plan. In selected embodiments, the IMMW PPDU may be transmitted using a single tone plan that is applied to all fields of the first IMMW preamble portion, IMMW SIG field, and the second IMMW preamble portion. In other selected embodiments, the IMMW PPDU may be transmitted using a first tone plan that is applied to the first IMMW preamble portion and IMMW SIG field, and using a second tone plan that is applied to at least the second IMMW preamble portion, data and postamble field. In other selected embodiments, the IMMW PPDU is transmitted by steering the first IMMW preamble portion and IMMW SIG field with a first Sector Level Sweep (SLS) best beam, and steering the multiple training fields through a plurality of finer beam refinement protocol (BRP) beams.

In another form, there is provided a first wireless device, system, and associated method of operation. As disclosed, the first wireless device includes a plurality of wireless transceivers, a memory including operational instructions, and one or more processing modules operably coupled to the plurality of wireless transceivers and the memory, where the one or more processing modules are configured to execute the operational instructions to operate a wireless personal network in accordance with Institute of Electrical and Electronics Engineers (IEEE) 802.11 protocol in a millimeter-wave frequency band. In particular, the one or more processing modules are configured to execute the operational instructions for generating, by wireless device, an Integrated Millimeter Wave (IMMW) physical layer protocol data unit (PPDU) which comprises a first IMMW preamble portion and an IMMW signaling field, and a second IMMW preamble portion. In addition, the one or more processing modules are configured to execute the operational instructions for transmitting the IMMW PPDU over at least a first signal bandwidth using at least a first tone plan.

Although the described exemplary embodiments disclosed herein are directed to wireless communication station (STA) devices which use 802.11bq encoding techniques to signal IMMW signaling, the present invention is not necessarily limited to the example embodiments which illustrate inventive aspects of the present invention that are applicable to a wide variety of circuit designs and operations. Thus, the particular embodiments disclosed above are illustrative only and should not be taken as limitations upon the present invention, as the invention may be modified and practiced in different but equivalent manners apparent to those skilled in the art having the benefit of the teachings herein. Accordingly, the identification of the circuit design and configurations provided herein is merely by way of illustration and not limitation and other circuit arrangements may be used. Accordingly, the foregoing description is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

At least some of the various blocks, operations, and techniques described above may be implemented utilizing hardware, a processor executing firmware instructions, a processor executing software instructions, or any combination thereof. When implemented utilizing a processor executing software or firmware instructions, the software or firmware instructions may be stored in any computer readable memory such as on a magnetic disk, an optical disk, or other storage medium, in a RAM or ROM or flash memory, processor, hard disk drive, optical disk drive, tape drive, etc. The software or firmware instructions may include machine readable instructions that, when executed by one or more processors, cause the one or more processors to perform various acts. When implemented in hardware, the hardware may comprise one or more of discrete components, an integrated circuit, an application-specific integrated circuit (ASIC), a programmable logic device (PLD), etc.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method for operating a wireless personal area network in accordance with IEEE 802.11 protocol in a millimeter-wave frequency band using orthogonal frequency domain multiplexing (OFDM), comprising:
generating, by a first STA device, an Integrated Millimeter Wave (IMMW) physical layer protocol data unit (PPDU) which comprises a first IMMW preamble portion and an IMMW signaling (SIG) field, and a second IMMW preamble portion; and
transmitting the IMMW PPDU over at least a first signal bandwidth using at least a first tone plan.

2. The method of claim 1, where the first IMMW preamble portion further comprises a legacy preamble portion comprising a legacy short training field (L-STF) and a legacy long training field (L-LTF) positioned in front of the SIG field.

3. The method of claim 1, where the IMMW SIG field further comprises a universal signaling (U-SIG) field which comprises version independent information bits, and additional IMMW-SIG subfield(s), carrying user information or training beam information.

4. The method of claim 3, where the U-SIG field encodes a duration sub-field.

5. The method of claim 1, where the second IMMW preamble portion comprises an IMMW-STF field and an IMMW-LTF field.

6. The method of claim 1, where the second IMMW preamble portion comprises an IMMW-STF field, an IMMW-LTF field, and an IMMW-SIG field.

7. The method of claim 1, where the IMMW PPDU is transmitted using a single tone plan that is applied to all fields of the first IMMW preamble portion, IMMW SIG field, and the second IMMW preamble portion.

8. The method of claim 1, where the IMMW PPDU is transmitted using a first tone plan that is applied to the first IMMW preamble portion and IMMW SIG field, and using a second tone plan that is applied to at least the second IMMW preamble portion, data and postamble field.

9. The method of claim 1, where the IMMW PPDU is an IMMW data PPDU comprising a data field positioned after the second IMMW preamble portion.

10. The method of claim 1, where the IMMW PPDU is an IMMW duplicate PPDU that is a duplication of a base bandwidth PPDU to transmit a control packet to one or more additional STAs with different bandwidths.

11. The method of claim 1, where the IMMW PPDU is an IMMW null data packet (NDP) PPDU that is a single user PPDU that does not include a data field.

12. The method of claim 11, where the first IMMW preamble portion uses smaller bandwidth than the second IMMW preamble portion.

13. The method of claim 11, where the first IMMW preamble portion has longer duration than that of the single user PPDU.

14. The method of claim 1, where the IMMW PPDU is an IMMW null data packet (NDP) PPDU that comprises multiple training fields for use with beam refinement protocol (BRP) training.

15. The method of claim 14,
where transmitting the IMMW PPDU comprises:
steering the first IMMW preamble portion and IMMW SIG field with a first Sector Level Sweep (SLS) best beam, and
steering the multiple training fields through a plurality of finer beam refinement protocol (BRP) beams.

16. The method of claim 1, where generating the IMMW PPDU further comprises generating a legacy signal field in the first IMMW preamble portion.

17. The method of claim 16, where the legacy signal field comprises four edge tones that are used for channel estimation.

18. The method of claim 16, where the U-SIG field comprises a Cyclic Redundancy Check (CRC) value that is computed from content contained in the legacy signal field and content contained in the U-SIG field.

19. The method of claim 16, where the legacy signal field comprises a length subfield and one or more reserved fields.

20. The method of claim 16, where content from the legacy signal field is jointly encoded with content from the U-SIG field.

21. The method of claim 20, where a SIGNAL TAIL subfield from the legacy signal field is redefined.

22. The method of claim 16, where the U-SIG field has one symbol containing version-independent information.

23. A first wireless device comprising:
a plurality of wireless transceivers;
memory including operational instructions; and
one or more processing modules operably coupled to the plurality of wireless transceivers and the memory,
wherein the one or more processing modules are configured to execute the operational instructions to operate a wireless personal network in accordance with Institute of Electrical and Electronics Engineers (IEEE) 802.11 protocol in a millimeter-wave frequency band by:
generating, by the first wireless device, an Integrated Millimeter Wave (IMMW) physical layer protocol data unit (PPDU) which comprises a first IMMW preamble portion and an IMMW signaling field, and a second IMMW preamble portion; and
transmitting, by the first wireless device, the IMMW PPDU over at least a first signal bandwidth using at least a first tone plan.
